(19) United States
(12) Patent Application Publication
(10) Pub. No.: US 2024/0054269 A1
(43) Pub. Date: Feb. 15, 2024

(54) Method, device, electronic equipment and computer-readable storage medium for lifetime prognosis of rechargeable-battery based on cumulative-consumption-indicators

(71) Applicant: Yueqin Cui, LuoYang (CN)

(72) Inventors: Dongzhen Lyu, LuoYang (CN); Yueqin Cui, LuoYang (CN)

(21) Appl. No.: 18/163,357

(22) Filed: Feb. 2, 2023

Related U.S. Application Data
(63) Continuation of application No. PCT/CN2022/097748, filed on Jun. 9, 2022.

(30) Foreign Application Priority Data
Jul. 15, 2021 (CN) 2021107987635
Oct. 11, 2021 (CN) 2021111787222
Dec. 12, 2021 (CN) 2021115133275
Jun. 9, 2022 (WO) PCT/CN2022/097748

(51) Int. Cl. G06F 30/27; H02J 7/00

(52) U.S. Cl. CPC G06F 30/27; H02J 7/0047

(57) ABSTRACT

The present Disclosure belongs to the technical field related to the lifetime prognosis of rechargeable-batteries, and discloses a method, device, electronic equipment and computer-readable storage medium for lifetime prognosis of rechargeable-battery based on cumulative-consumption-indicators, which is capable to deal with random charging and discharging, irregular resting, calendar ageing, changing operation-conditions or some other phenomena that widely exist in the practical applications of rechargeable-batteries.

The present Disclosure designs and adopts the comprehensive-lifetime-index and health-status-index to describe the degradation process of the rechargeable-battery, and may also consider different operating-conditions and their influence on degradation trend, and further could make feature fusion with one or a plurality of the comprehensive-lifetime-indicators or one or a plurality of the key-performance-indicators according to actual needs. As a result, the disclosure significantly improves the accuracy of the remaining-lifetime prognosis of rechargeable-batteries, especially in daily practical applications.

### CROSS-REFERENCE TO RELATED APPLICATIONS

This application is a Bypass Continuation of the International Patent Application No. PCT/CN2022/097748 with an international filing date of Jun. 9, 2022, designating the United States, now pending, and further claims foreign priority benefits to Chinese Patent Application No. 202111513327.5 filed Dec. 12, 2021, Chinese Patent Application No. 202111178722.2 filed Oct. 11, 2021, and Chinese Patent Application No. 202110798763.5 filed Jul. 15, 2021. The contents of all of the aforementioned applications, including any intervening amendments thereto, are incorporated herein by reference. Inquiries from the public to applicants or assignees concerning this document or the related applications should be email to: lvdongzhen@yeah.net or lvdongzhen@hrbeu.edu.cn, both of which are accessible.

### PRIOR ART

Rechargeable-batteries are widely used in modern daily life, but they also have the problem of gradually performance degradation. Therefore, it is necessary to consider the degradation phenomenon and its influence on the working performances of rechargeable-battery. Monitoring and modelling the degradation process of rechargeable-batteries, then predicting and estimating the future development of their health status, could greatly improve the reliability of rechargeable-batteries. At the same time, the maintenance and replacement of rechargeable-batteries can also be arranged according to those prognosis results, which has very important practical value and significance.

Most traditional lifetime prognosis methods for rechargeable-battery are developed based on the rechargeable-battery degradation experiment under idealized conditions. In the idealized experiment, the charging process and the discharging process are alternatively performed on professional equipment, so that the integrity of the charging process and the discharging process can be easily guaranteed. Therefore, most traditional lifetime prognosis methods for rechargeable-battery adopt the number of charging-discharging cycles (also referred as accumulated amount of the merge of charging and discharging iteration in the present Disclosure) as the lifetime index.

However, in daily practical applications, the usage approach and usage frequency of the rechargeable-battery rely heavily on user's random usage habits. In such randomized usage scenarios, charging processes and discharging processes commonly are discontinuous and incomplete, so that the corresponding degradation-data has poor regularity and is very difficult to analyze.

According to user's usage habits in daily utilization, the rechargeable-battery might need to be charged before it is fully discharged, or it might need to be discharged before it is fully charged. At the same time, there might have suspension and resumption situation during each of the discharging processes, such as temporary replacement of the charging site or temporary power failure in the charging site. In addition, when the user's charging cable has poor contact problem, some extremely short charging processes might frequently occur in a short period. For mobile phones, unless the power is turned off during each of the charging processes, or there exist specific software settings, the charging process must be accompanied with a consumption process. While for portable notebook, there might have the long-term plug-in scenario, and the charging and discharging process in this scenario is difficult to define. Therefore, in the practical application of rechargeable-batteries, there basically has no idealized operating-conditions with alternative and complete charging and discharging processes. Obviously, it is inaccurate and unreasonable to take the number of charging-discharging cycles as lifetime index.

### BACKGROUND OF THE INVENTION

The present Disclosure belongs to the technical field related to lifetime prognosis of rechargeable-batteries, and more specifically, relates to a method, device, electronic equipment and computer-readable storage medium for lifetime prognosis of rechargeable-battery based on cumulative-consumption-indicators.

### SUMMARY OF THE INVENTION

In summary, the degradation process of the rechargeable-battery is very complicated, and taking the charging-discharging cycles solely as the lifetime index to describe the degradation process is obviously inaccurate and unreasonable. After conducting a lot of experimental research and theoretical analysis, the inventor found that introducing the cumulative-consumption-indicator to construct the lifetime index is very suitable for describing the degradation process of the rechargeable-battery under random charging and discharging settings.

In view of this, the present Disclosure discloses a method, device, electronic equipment and computer-readable storage medium for lifetime prognosis of rechargeable-battery based on cumulative-consumption-indicators, for accurately predicting the rechargeable-battery lifetime in the actual daily usage, and then providing the timely warning to ensure the safety of the rechargeable-battery during its operation. Compared with traditional prognosis methods based on charging-discharging cycles or service time, this disclosure can improve the accuracy of the prognosis results by more than 80%.

According to the first aspect of embodiments of the present Disclosure, a lifetime prognosis method for a rechargeable-battery based on the cumulative-consumption-indicators is provided, which is characterized in that the method comprising: step 101, constructing a comprehensive-lifetime-index, using one or a plurality of the cumulative-consumption-indicators, for the rechargeable-battery; step 103, constructing, at an appropriate modelling moment, a dynamic-degradation-model for the rechargeable-battery; step 105, obtaining available-degradation-data-samples of the rechargeable-battery as model-inputs of the dynamic-degradation-model; step 107, predicting a remaining-lifetime of the rechargeable-battery, at a prognosis-execution-time, using the dynamic-degradation-model.

In some embodiments, wherein the dynamic-degradation-model is used to describe a dynamic degradation pattern of the rechargeable-battery that characterized by decay in the value of the comprehensive-lifetime-index, during a degradation process of the rechargeable-battery, as the value of the comprehensive lifetime index constantly increases.

In some embodiments, wherein constructing the comprehensive-lifetime-index comprises: selecting one of the cumulative-consumption-indicators as the comprehensive-lifetime-index.

In some embodiments, wherein the cumulative-consumption-indicators comprise: an accumulated amount obtained by accumulating values of a usage-metric of the rechargeable-battery; but the cumulative-consumption-indicators do not comprise: an accumulated amount of the charging iteration, an accumulated amount of the discharging iteration, an accumulated amount of the merge of charging and discharging iteration, or an accumulated amount of the service duration.

In some embodiments, wherein the available-degradation-data-samples comprise: degradation-data sampled in real-time, the degradation-data sampled at all of historical spans or moments, or the degradation-data sampled at partial of the historical spans or moments.

In some embodiments, wherein the degradation-data comprises: performance monitoring data that are closely related to the degradation process of the rechargeable-battery.

In some embodiments, wherein the cumulative-consumption-indicators further comprise: an accumulated amount of the charging-electricity-quantity, an accumulated amount of the discharging-electricity-quantity, or an accumulated amount of the merge of absolute charging and discharging electricity-quantity.

In some embodiments, wherein the cumulative-consumption-indicators further comprise: an accumulated amount of the charging-electric-work, an accumulated amount of the discharging-electric-work, or an accumulated amount of the merge of absolute charging and discharging electric-work.

In some embodiments, wherein the cumulative-consumption-indicators further comprise: an accumulated amount of the charging duration, an accumulated amount of the discharging duration, or an accumulated amount of the merge of charging and discharging duration.

In some embodiments, wherein the cumulative-consumption-indicators further comprise: an accumulated amount of the resting iteration, or an accumulated amount of the resting duration.

In some embodiments, wherein the process to acquire a value of one of the cumulative-consumption-indicators at a sampling time, comprise: selecting all of the historical spans or moments during a period from a production date of the rechargeable-battery to the sampling time as an accumulation-range, then selecting the usage-metric of the rechargeable-battery according to actual needs as object for accumulation, and then accumulating the values of the usage-metric within the accumulation-range to get an accumulated result, finally using the accumulated result as the value of one of the cumulative-consumption-indicators at the sampling time.

In some embodiments, wherein constructing the health-status-index comprises: selecting one of the key-performance-indicators as the health-status-index.

In some embodiments, wherein one of the key-performance-indicators is defined as one of working performances of the rechargeable-battery, and a value of the one of the working performances will gradually decay with long-term usage of the rechargeable-battery; specifically, a value of the one of the key-performance-indicators at the sampling time is also the value of the one of the working performances at the sampling time.

In some embodiments, wherein a failure threshold is a value within feasible value range of the health-status-index of the rechargeable-battery, and the rechargeable-battery fails when a value of the health-status-index decays to the failure threshold.

In some embodiments, wherein the key-performance-indicators comprise: an actual-quantity-capacity, or an attenuation of the actual-quantity-capacity.

In some embodiments, wherein the key-performance-indicators further comprise: an actual-internal-resistance, or an attenuation of the actual-internal-resistance.

In some embodiments, wherein the key-performance-indicators further comprise: an actual-work-capacity, or an attenuation of the actual-work-capacity.

In some embodiments, wherein the rechargeable-battery in physical structure comprise: a battery individual composed by a single battery cell, a battery pack composed by multiple battery cells connected in series or parallel, or a battery cluster composed by organic integration of multiple battery cells or battery packs.

In some embodiments, wherein the rechargeable-battery in chemical structure comprise: lithium battery, lithium-ion battery, lithium-sulfur battery, sodium battery, sodium-ion battery, aluminum battery, aluminum-ion battery, graphene battery, sulfur battery, nickel-metal hydride battery, lead storage battery, all-solid-state battery, solid-liquid hybrid battery, metal battery, metal-ion battery, air battery, cylindrical battery, polymer battery, power battery, halide battery, silicon-based battery, supercapacitor, or other recyclable power storage device.

In some embodiments, wherein the degradation-data further comprises: values of one or a plurality of the cumulative-consumption-indicators, or values of one or a plurality of the key-performance-indicators.

In some embodiments, wherein the remaining-lifetime equals to a difference between a failure-lifetime and a current-lifetime, which represents a remaining usable amount of the comprehensive-lifetime-index before the rechargeable-battery fails; specifically, a value of the remaining-lifetime at the prognosis-execution-time is also a difference between a value of the failure-lifetime and a value of the current-lifetime at the prognosis-execution-time.

In some embodiments, wherein the failure-lifetime equals to a value of the comprehensive-lifetime-index when the rechargeable-battery fails; specifically, the value of the failure-lifetime is also the value of the comprehensive-lifetime-index at the time when the value of the health-status-index decays to the failure threshold.

In some embodiments, wherein the current-lifetime, at each the prognosis-execution-time, is also the value of the comprehensive-lifetime-index; specifically, the value of the current-lifetime at the prognosis-execution-time is also the value of the comprehensive-lifetime-index at the prognosis-execution-time.

In some embodiments, wherein an approach for setting the failure threshold comprise: preset the failure threshold in advance, or setting the failure threshold according to an inherent law inferred from a priori-group of the degradation-data.

In some embodiments, wherein constructing, at the appropriate modelling moment, the dynamic-degradation-model for the rechargeable-battery, comprise: selecting an empirical mathematical model according to actual needs, and then setting model parameters of the empirical mathematical model, and finally combining the empirical mathematical model with the model parameters as the dynamic-degradation-model; values of the model parameters can be preset in advance or be obtained by training the empirical mathematical model based on the priori-group of the degradation-data.

In some embodiments, wherein constructing, at the appropriate modelling moment, the dynamic-degradation-model for the rechargeable-battery, further comprise: selecting a neural network prognosis model according to actual needs, and then training parameters and hyperparameters of the neural network prognosis model based on the priori-group of the degradation-data, finally combining the neural network prognosis model with its parameters and hyperparameters as the dynamic-degradation-model.

In some embodiments, wherein the priori-group of the degradation-data comprise: the available-degradation-data-samples of the rechargeable-battery, or the available-degradation-data-samples of other-similar-batteries that are similar or identical to the rechargeable-battery.

In some embodiments, wherein the lifetime prognosis method further comprising: collecting, at an appropriate collecting moment, the available-degradation-data-samples of the rechargeable-battery.

In some embodiments, wherein the lifetime prognosis method further comprising: collecting, at the appropriate collecting moment, the available-degradation-data-samples of other-similar-batteries that are similar or identical to the rechargeable-battery.

In some embodiments, wherein constructing the health-status-index comprises: using a performance feature fusion approach, with a plurality of the key-performance-indicators used as input features, to construct and output the health-status-index; specifically, using two, three, four, or a plurality of the key-performance-indicators as the input features, then the input features are organically fused using the performance feature fusion approach to form and output the health-status-index.

In some embodiments, wherein constructing the comprehensive-lifetime-index comprises: using a lifetime feature fusion approach, with a plurality of the cumulative-consumption-indicators used as the input features, to construct and output the comprehensive-lifetime-index; specifically, using two, three, four, or a plurality of the cumulative-consumption-indicators as the input features, then the input features are organically fused using the lifetime feature fusion approach to form and output the comprehensive-lifetime-index.

In some embodiments, wherein constructing the comprehensive-lifetime-index or the health-status-index using the lifetime feature fusion approach or performance feature fusion approach comprises: setting weight-coefficients for each of the input features, then weighting each of the input features according to the weight-coefficients, and finally summing up the input features to build and output the comprehensive-lifetime-index or the health-status-index; values of the weight-coefficients can be preset in advance or be obtained by training based on the priori-group of the degradation-data, but the values of the weight-coefficients corresponding to each of the input features is all non-zero, and the values of the weight-coefficients are not completely equal to each other.

In some embodiments, wherein constructing the comprehensive-lifetime-index or the health-status-index using the lifetime feature fusion approach or performance feature fusion approach further comprises: selecting a neural network feature model to process the input features, then taking the output of the neural network feature model as the comprehensive-lifetime-index or the health-status-index; the neural network feature model with its parameters and hyperparameters can be preset in advance or be obtained by training based on the priori-group of the degradation-data.

In some embodiments, wherein the actual-quantity-capacity comprises a maximum electricity quantity storage capacity of the rechargeable-battery in a fully charged state, which represents a charging electricity quantity limitation or a discharging electricity quantity limitation of the rechargeable-battery, and a value of the actual-quantity-capacity will gradually decay with the long-term usage of the rechargeable-battery.

In some embodiments, wherein the value of the actual-quantity-capacity comprises: an amount of the charging-electricity-quantity that can be charged into the rechargeable-battery during a complete charging process for charging the rechargeable-battery from a fully discharged state to the fully charged state, or an amount of the discharging-electricity-quantity that can be discharged out of the rechargeable-battery during a complete discharging process for discharging the rechargeable-battery from the fully charged state to the fully discharged state.

In some embodiments, wherein the actual-work-capacity comprises the maximum electric work storage capacity of the rechargeable-battery in the fully charged state, which represents a charging electric work limitation or a discharging electric work limitation of the rechargeable-battery, and a value of the actual-work-capacity will gradually decay with the long-term usage of the rechargeable-battery.

In some embodiments, wherein the value of the actual-work-capacity comprises: an amount of the charging-electric-work that can be charged into the rechargeable-battery during the complete charging process for charging the rechargeable-battery from the fully discharged state to the fully charged state; or an amount of the discharging-electric-work that can be discharged out of the rechargeable-battery during the complete discharging process for discharging the rechargeable-battery from the fully charged state to the fully discharged state.

In some embodiments, wherein an alternative approach for selecting the accumulation-range, during the process to acquire the value of one of the cumulative-consumption-indicators at the sampling time, further comprises: the first viable option that selecting all of the historical spans or moments during a period from a put-into-use date of the rechargeable-battery to the sampling time as the accumulation-range, the second viable option that appointing a certain fixed time as an initial accumulation point then selecting all of the historical spans or moments during a period from the initial accumulation point to the sampling time as the accumulation-range, or the third viable option that selecting partial of the historical spans or moments during a period from the production date of the rechargeable-battery to the sampling time as the accumulation-range.

In some embodiments, wherein collecting, at the appropriate collecting moment, the available-degradation-data-samples, specifically of one of the individual batteries from the rechargeable-battery or the other-similar-batteries, comprise: the first viable option that collecting the degradation-data in real-time of the one of the individual batteries at the appropriate collecting moment, the second viable option that collecting the degradation-data in history of the one of the individual batteries at all of the historical spans or moments during a period from the production date of the one of the individual batteries to the appropriate collecting moment, or the third viable option that collecting the degradation-data in history of the one of the individual batteries at partial of the historical spans or moments during the period from the production date of the one of the individual batteries to the appropriate collecting moment.

In some embodiments, wherein a function of the dynamic-degradation-model further comprises: be able to predict one or a plurality of prognosis-features of the rechargeable-battery.

In some embodiments, wherein the lifetime prognosis method further comprising: predicting one or a plurality of the prognosis-features of the rechargeable-battery using the dynamic-degradation-model.

In some embodiments, wherein the prognosis-features comprise: an optimal planned maintenance time, an optimal planned replacement time, the failure-lifetime, the current-lifetime, a relative remaining-lifetime, or a relative current-lifetime.

In some embodiments, wherein the relative remaining-lifetime comprises a ratio of the remaining-lifetime to the failure-lifetime; wherein the relative current-lifetime comprises a ratio of the current-lifetime to the failure-lifetime.

In some embodiments, wherein the prognosis-features further comprise: a remaining-cumulable-amount of one of the cumulative-consumption-indicators before the rechargeable-battery fails, the value of one of the cumulative-consumption-indicators when the rechargeable-battery fails, future-dynamics between the health-status-index and the comprehensive-lifetime-index, future-dynamics between one of the key-performance-indicators and the comprehensive-lifetime-index, future-dynamics between one of the cumulative-consumption-indicators and the health-status-index, or future-dynamics between one of the cumulative-consumption-indicators and one of the key-performance-indicators.

In some embodiments, wherein the future-dynamics between the health-status-index and the comprehensive-lifetime-index comprise: within a future-lifetime-range starting from the prognosis-execution-time for future running of the rechargeable-battery, corresponding values of the health-status-index when the comprehensive-lifetime-index takes different values, or corresponding values of the comprehensive-lifetime-index when the health-status-index takes different values.

In some embodiments, wherein the future-dynamics between one of the key-performance-indicators and the comprehensive-lifetime-index comprise: within the future-lifetime-range starting from the prognosis-execution-time for future running of the rechargeable-battery, corresponding values of one of the key-performance-indicators when the comprehensive-lifetime-index takes different values, or the corresponding values of the comprehensive-lifetime-index when one of the key-performance-indicators takes different values.

In some embodiments, wherein the future-dynamics between one of the cumulative-consumption-indicators and the health-status-index comprise: within the future-lifetime-range starting from the prognosis-execution-time for future running of the rechargeable-battery, corresponding values of one of the cumulative-consumption-indicators when the health-status-index takes different values, or the corresponding values of the health-status-index when one of the cumulative-consumption-indicators takes different values.

In some embodiments, wherein the future-dynamics between one of the cumulative-consumption-indicators and one of the key-performance-indicators comprise: within the future-lifetime-range starting from the prognosis-execution-time for future running of the rechargeable-battery, the corresponding values of one of the key-performance-indicators when one of the cumulative-consumption-indicators takes different values, or the corresponding values of one of the cumulative-consumption-indicators when one of the key-performance-indicators takes different values.

In some embodiments, wherein the degradation-data further comprises: values of one or a plurality of operating-conditions; generally, changes in value of one or a plurality of the operating-conditions may affect the working performances of the rechargeable-battery in use, and then may affect the dynamic degradation pattern of the rechargeable-battery.

In some embodiments, wherein the operating-conditions comprise: changes in value of a battery terminal voltage, changes in value of a battery terminal current, changes in value of a battery terminal power, changes in value of a battery body temperature, or changes in value of an external environment temperature, within each of charging processes or each of discharging processes of the rechargeable-battery.

In some embodiments, wherein the operating-conditions further comprise: mean average of the battery terminal voltage, mean average of the battery terminal current, mean average of the battery terminal power, mean average of the battery body temperature, or mean average of the external environment temperature, within each of the charging processes or each of the discharging processes of the rechargeable-battery.

In some embodiments, wherein the operating-conditions further comprise: charging cut-off current of the rechargeable-battery in each of the charging processes, or discharging cut-off voltage of the rechargeable-battery in each of the discharging processes; the charging cut-off current refers to a preset current limit at which the rechargeable-battery should not continue to charge when the battery terminal current drops to this preset current limit during each of the charging processes; the discharging cut-off voltage refers to a preset voltage limit at which the rechargeable-battery should not continue to discharge when the battery terminal voltage drops to this preset voltage limit during each of the discharging processes.

In some embodiments, wherein the key-performance-indicators further comprise: one or a plurality of the cumulative-consumption-indicators.

In some embodiments, wherein the function of the dynamic-degradation-model further comprises: be able to consider influence of the operating-conditions on the dynamic degradation pattern of the rechargeable-battery.

In some embodiments, wherein predicting the remaining-lifetime of the rechargeable-battery further comprises: considering influence of future-operating-conditions on the dynamic degradation pattern of the rechargeable-battery, then adopting estimation results of the future-operating-conditions of the rechargeable-battery as additional model-inputs of the dynamic-degradation-model, finally using the dynamic-degradation-model to predict the remaining-lifetime of the rechargeable-battery.

In some embodiments, wherein the future-operating-conditions comprise: the values of one or a plurality of the operating-conditions within the future-lifetime-range starting from the prognosis-execution-time for future running of the rechargeable-battery.

In some embodiments, wherein the lifetime prognosis method further comprising: estimating the future-operating-conditions of the rechargeable-battery.

In some embodiments, wherein a condition estimation approach for estimating the future-operating-conditions of the rechargeable-battery comprises: the first viable option that estimating the future-operating-conditions of the rechargeable-battery according to a pre-established future utilization planning, or the second viable option that estimating the future-operating-conditions of the rechargeable-battery according to inherent changing patterns of the operating-conditions that can be inferred from the priori-group of the degradation-data.

In some embodiments, wherein estimating the future-operating-conditions of the rechargeable-battery further comprises: the first viable option that assuming the values of one or a plurality of the operating-conditions will change with time during the future-lifetime-range and then using the condition estimation approach to estimate changing dynamics of one or a plurality of the operating-conditions over the future-lifetime-range, or the second viable option that assuming the values of one or a plurality of the operating-conditions will remain stable during the future-lifetime-range and then using the condition estimation approach to estimate mean values of one or a plurality of the operating-conditions over the future-lifetime-range.

In some embodiments, wherein predicting one or a plurality of the prognosis-features of the rechargeable-battery further comprises: considering influence of future-operating-conditions on the dynamic degradation pattern of the rechargeable-battery, then adopting estimation results of the future-operating-conditions of the rechargeable-battery as the additional model-inputs of the dynamic-degradation-model, finally using the dynamic-degradation-model to predict one or a plurality of the prognosis-features of the rechargeable-battery.

In some embodiments, wherein accumulating the values of the usage-metric within the accumulation-range to get an accumulated result, during the process to acquire the value of one of the cumulative-consumption-indicators at the sampling time, further comprise: accumulating, considering impacts of one or a plurality of the operating-conditions, the values of the usage-metric within the accumulation-range to get an accumulated result; wherein accumulating, considering the impacts of one or a plurality of the operating-conditions, the values of the usage-metric within the accumulation-range to get an accumulated result, comprise: obtaining the values of one or a plurality of the operating-conditions at each time within the accumulation-range, then generating values of weighted-coefficient for the values of one or a plurality of the operating-conditions at each time within the accumulation-range according to specific models or rules, and then obtaining values of weighted usage-metric at each time within the accumulation-range by multiplying the values of the usage-metric and the values of the weighted-coefficient at each time within the accumulation-range, and then accumulating the values of the weighted usage-metric over the accumulation-range to get the accumulated result, finally using the accumulated result as the value of one of the cumulative-consumption-indicators at the sampling time; the specific models or rules can be obtained by training based on the priori-group of the degradation-data or can be preset in advance.

In some embodiments, wherein the cumulative-consumption-indicators, under the precondition of considering the impacts of one or a plurality of the operating-conditions when accumulating the values of the usage-metric within the accumulation-range to get an accumulated result, further comprise: the accumulated amount of the charging iteration, the accumulated amount of the discharging iteration, the accumulated amount of the merge of charging and discharging iteration, or the accumulated amount of the service duration.

In some embodiments, wherein the cumulative-consumption-indicators further comprise: an accumulated amount of the actual workload generated by the battery powered equipment, an accumulated amount of the actual work generated by the battery powered equipment, or an accumulated amount of the actual mileage generated by the battery powered vehicle;

In some embodiments, wherein the key-performance-indicators further comprise: an actual workload generated by the battery powered equipment by discharging the rechargeable-battery from the fully charged state to the fully discharged state, an actual work generated by the battery powered equipment by discharging the rechargeable-battery from the fully charged state to the fully discharged state, or an actual mileage generated by the battery powered vehicle by discharging the rechargeable-battery from the fully charged state to the fully discharged state.

In some embodiments, wherein the operating-conditions further comprise: changes in value of an operating-power of the battery powered equipment within each of the charging processes or each of the discharging processes, or mean average of the operating-power of the battery powered equipment within each of the charging processes or each of the discharging processes.

In some embodiments, wherein the operating-conditions further comprise: changes in value of a production-efficiency of the battery powered equipment within each of the charging processes or each of the discharging processes, or mean average of the production-efficiency of the battery powered equipment within each of the charging processes or each of the discharging processes.

In some embodiments, wherein the operating-conditions further comprise: changes in value of a driving speed of the battery powered vehicle within each of driving processes, or mean average of the driving speed of the battery powered vehicle within each of the driving processes.

In some embodiments, wherein the cumulative-consumption-indicators further comprise: an accumulated amount of one of the operating-conditions; specifically, the process to acquire the accumulated amount of one of the operating-conditions comprise: taking one of the operating-conditions as object for accumulation, then accumulating the values of one of the operating-conditions within the accumulation-range to get the accumulated result, finally using the accumulated result as the value of one of the cumulative-consumption-indicators at the sampling time;

In some embodiments, wherein the cumulative-consumption-indicators further comprise: an accumulated amount of the weighted charging-electric-work, an accumulated amount of the weighted discharging-electric-work, or an accumulated amount of the weighted merge of absolute charging and discharging electric-work.

In some embodiments, wherein the weighted charging-electric-work comprise: a ratio of the charging-electric-work to a rated-work-capacity, a ratio of the charging-electric-work to an initial-work-capacity, or a ratio of the charging-electric-work to the actual-work-capacity; wherein the weighted discharging-electric-work comprise: a ratio of the discharging-electric-work to the rated-work-capacity, a ratio of the discharging-electric-work to the initial-work-capacity, or a ratio of the discharging-electric-work to the actual-work-capacity.

In some embodiments, wherein constructing the comprehensive-lifetime-index comprises: using the lifetime feature fusion approach, with one or a plurality of traditional-lifetime-indicators and one or a plurality of the cumulative-consumption-indicators used as the input features, to construct and output the comprehensive-lifetime-index; specifically, using one or a plurality of the traditional-lifetime-indicators and one or a plurality of the cumulative-consumption-indicators as the input features, then the input features are organically fused using the lifetime feature fusion approach to form and output the comprehensive-lifetime-index.

In some embodiments, wherein the traditional-lifetime-indicators comprise: the accumulated amount of the charging iteration, the accumulated amount of the discharging iteration, the accumulated amount of the merge of charging and discharging iteration, or the accumulated amount of the service duration.

In some embodiments, wherein the prognosis-features further comprise: a remaining-cumulable-amount of one of the traditional-lifetime-indicators before the rechargeable-battery fails, a value of one of the traditional-lifetime-indicators at the time when the rechargeable-battery fails, the future-dynamics between one of the traditional-lifetime-indicators and the health-status-index, or the future-dynamics between one of the traditional-lifetime-indicators and one of the key-performance-indicators.

In some embodiments, wherein the future-dynamics between one of the traditional-lifetime-indicators and the health-status-index comprise: within the future-lifetime-range starting from the prognosis-execution-time for future running of the rechargeable-battery, corresponding values of one of the traditional-lifetime-indicators when the health-status-index takes different values, or the corresponding values of the health-status-index when one of the traditional-lifetime-indicators takes different values.

In some embodiments, wherein the future-dynamics between one of the traditional-lifetime-indicators and one of the key-performance-indicators comprise: within the future-lifetime-range starting from the prognosis-execution-time for future running of the rechargeable-battery, the corresponding values of one of the key-performance-indicators when one of the traditional-lifetime-indicators takes different values, or the corresponding values of one of the traditional-lifetime-indicators when one of the key-performance-indicators takes different values.

In some embodiments, wherein the cumulative-consumption-indicators further comprise: an accumulated amount of the weighted charging-electricity-quantity, an accumulated amount of the weighted discharging-electricity-quantity, or an accumulated amount of the weighted merge of absolute charging and discharging electricity-quantity.

In some embodiments, wherein the weighted charging-electricity-quantity comprise: a ratio of the charging-electricity-quantity to a rated-quantity-capacity, a ratio of the charging-electricity-quantity to an initial-quantity-capacity, or a ratio of the charging-electricity-quantity to the actual-quantity-capacity; wherein the weighted discharging-electricity-quantity comprise: a ratio of the discharging-electricity-quantity to the rated-quantity-capacity, a ratio of the discharging-electricity-quantity to the initial-quantity-capacity, or a ratio of the discharging-electricity-quantity to the actual-quantity-capacity.

According to the second aspect of embodiments of the present Disclosure, a lifetime prognosis device for the rechargeable-battery based on the cumulative-consumption-indicators is provided, comprising: a comprehensive-lifetime-index building module, which is configured to construct the comprehensive-lifetime-index, using one or a plurality of the cumulative-consumption-indicators, for the rechargeable-battery; a dynamic-degradation-model building module, which is configured to construct, at the appropriate modelling moment, the dynamic-degradation-model for the rechargeable-battery; a model-inputs building module, which is configured to obtain the available-degradation-data-samples of the rechargeable-battery as the model-inputs of the dynamic-degradation-model; a remaining-lifetime prognosis module, which is configured to predict the remaining-lifetime of the rechargeable-battery, at the prognosis-execution-time, using the dynamic-degradation-model.

According to the third aspect of embodiments of the present Disclosure, an electronic equipment is provided, comprised of: a memory module, which is configured to store computer instructions; a processor module, coupled to the memory module, which is configured to execute the computer instructions stored in the memory module to realize the lifetime prognosis method for rechargeable-battery based on the cumulative-consumption-indicators as described in any of the above embodiments.

According to the fourth aspect of embodiments of the present Disclosure, a computer-readable storage medium is provided, wherein the computer-readable storage medium stores the computer instructions, and when the computer instructions are executed by the processor module, the lifetime prognosis method for the rechargeable-battery based on the cumulative-consumption-indicators as described in any of above embodiments can be realized.

It should be understood that above general descriptions and the following detailed descriptions are exemplary only and are not restrictive of the present Disclosure.

The present Disclosure designs and adopts the comprehensive-lifetime-index and health-status-index to describe the degradation process of the rechargeable-battery, and may also consider different operating-conditions and their influence on degradation trend, and further could make feature fusion with one or a plurality of the comprehensive-lifetime-indicators or one or a plurality of the key-performance-indicators according to actual needs. As a result, the disclosure significantly improves the accuracy of the remaining-lifetime prognosis of rechargeable-batteries, especially in daily practical applications.

### BRIEF DESCRIPTION OF DRAWINGS

In order to clearly illustrate the technical solution in embodiments of the present Disclosure, drawings related to embodiments will be briefly introduced below. Obviously, drawings in the following description are only some implementations of the present Disclosure. For ordinary technicians in the relevant field, other drawings can be easily obtained based on these drawings without any creative effort.

FIG. 1 is a flow diagram illustrating a lifetime prognosis method for rechargeable-battery based on the cumulative-consumption-indicators according to an exemplary embodiment.

FIG. 2 is a block diagram illustrating a lifetime prognosis device for rechargeable-battery based on the cumulative-consumption-indicators according to an exemplary embodiment.

FIG. 3 is a block diagram illustrating an electronic equipment according to an exemplary embodiment.

FIG. 4 is a block diagram illustrating a computer-readable storage medium according to an exemplary embodiment.

FIG. 5 is a flow diagram illustrating a lifetime prognosis method for rechargeable-battery based on the cumulative-consumption-indicators according to another exemplary embodiment.

FIG. 6 is a flow diagram illustrating a lifetime prognosis method for rechargeable-battery based on the cumulative-consumption-indicators according to another exemplary embodiment.

FIG. 7 is a flow diagram illustrating a lifetime prognosis method for rechargeable-battery based on the cumulative-consumption-indicators according to another exemplary embodiment.

FIG. 8 is a flow diagram illustrating a lifetime prognosis method for rechargeable-battery based on the cumulative-consumption-indicators according to another exemplary embodiment.

FIG. 9 is a flow diagram illustrating a lifetime prognosis method for rechargeable-battery based on the cumulative-consumption-indicators according to another exemplary embodiment.

FIG. 10 is a block diagram illustrating a lifetime prognosis device for rechargeable-battery based on the cumulative-consumption-indicators according to another exemplary embodiment.

FIG. 11 is a block diagram illustrating a lifetime prognosis device for rechargeable-battery based on the cumulative-consumption-indicators according to another exemplary embodiment.

FIG. 12 is a block diagram illustrating a lifetime prognosis device for rechargeable-battery based on the cumulative-consumption-indicators according to another exemplary embodiment.

FIG. 13 is a block diagram illustrating a lifetime prognosis device for rechargeable-battery based on the cumulative-consumption-indicators according to another exemplary embodiment.

FIG. 14 is a block diagram illustrating a lifetime prognosis device for rechargeable-battery based on the cumulative-consumption-indicators according to another exemplary embodiment.

### DETAILED DESCRIPTION OF THE INVENTION

The following will provide various exemplary embodiments of the present Disclosure in detail with reference to the accompanying drawings. The description of the exemplary embodiments is only illustrative and shall not be taken as any restriction on the disclosure, its application or utilization. The disclosure can be implemented in many different forms, not limited to these embodiments described herein. These embodiments are provided so that this disclosure will be thorough and complete, and will fully convey the scope of the disclosure to those ordinary technicians in the relevant field. It should be noted that, unless otherwise specified, the relative arrangement of components and steps, the composition and values of materials described in these embodiments should be interpreted as merely illustrative rather than limiting.

The terms “first”, “second”, “third” and “fourth” used in this disclosure are used to distinguish different objects, not to describe a specific order. The terms “comprising”, “including”, “having” and “comprise” in the embodiments of the present Disclosure and any variations thereof are intended to cover nonexclusive inclusion. For example, a process, method, system, product or device that includes a series of steps or units need not be limited to those steps or units that are clearly listed, but can include other steps or units that are not clearly listed or are inherent to these processes, methods, products or devices.

All terms used in this disclosure (including technical terms or scientific terms) have the same meanings as those understood by ordinary technicians in the relevant field to which this disclosure belongs, unless otherwise specifically defined. It should also be understood that terms defined in general dictionaries (for example), should be interpreted as having meanings consistent with their meanings in the context of relevant technologies, and should not be interpreted in terms of idealized or highly formalized meanings, unless explicitly defined here.

The techniques, methods and equipment known to ordinary technicians in the relevant field might not be discussed in detail in the Description part of present Disclosure, but in appropriate cases, the techniques, methods, and equipment should be considered as a part of the Description part of present Disclosure.

The present Disclosure provides a method, device, electronic equipment and computer-readable storage medium for lifetime prognosis of rechargeable-battery based on cumulative-consumption-indicators, which can solve the phenomenon of changing operating-conditions and random charging and discharging phenomena that widely exist in the practical application of rechargeable-batteries, and improve the prognosis accuracy in predicting lifetime of rechargeable-battery in practice, thus have a very high application prospect.

FIG. 1 is a flow diagram illustrating a lifetime prognosis method for rechargeable-battery based on the cumulative-consumption-indicators according to an exemplary embodiment. In some embodiments, the lifetime prognosis method comprises steps 101-107.

Step 101, constructing a comprehensive-lifetime-index, using one or a plurality of the cumulative-consumption-indicators, for the rechargeable-battery.

Most traditional lifetime prognosis methods for rechargeable-battery adopt the accumulated amount of the merge of charging and discharging iteration as the lifetime index. However, in addition to the accumulated amount of the merge of charging and discharging iteration (number of charging-discharging cycles), rechargeable-batteries can also have many other types of cumulative-consumption-indicator, such as the cumulative amount of charging-electricity-quantity, the accumulated amount of the charging duration, the accumulated amount of the charging-electric-work, the accumulated amount of the discharging-electricity-quantity, etc.

However, in daily practical applications, the usage approach and usage frequency of the rechargeable-battery rely heavily on user's random usage habits. In such randomized usage scenarios, charging processes and discharging processes commonly are discontinuous and incomplete, so that the corresponding the degradation-data has poor regularity and is very difficult to analyze. According to user's usage habits in daily utilization, the rechargeable-battery might need to be charged before its is fully discharged, or it might need to be discharged before it is fully charged. For mobile phones, unless the power is turned off during each of the charging processes, or there exist specific software settings, the charging process must be accompanied with a consumption process (discharging). While for portable notebook, there might have the long-term plug-in scenario, and the charging and discharging process in this scenario is difficult to define. And at the same time, there might have suspension and resumption situation during each of the discharging processes, such as temporary replacement of the charging site or temporary power failure in the charging site. In addition, when the user's charging cable has poor contact problem, some extremely short charging processes might frequently occur in a short period. In addition, after the production of the rechargeable-battery, it might be stored in the warehouse for a certain period of time, that is, it will not be put into use immediately; and there might also have occasional shelving rest during the usage of the rechargeable-battery. Although the rechargeable-battery is not used during the storage or rest period, the passage of calendar service time will also cause the rechargeable-battery to age, thus the storage or rest period is also a feasible option for the construction of the cumulative-consumption-indicator.

In summary, the degradation process of the rechargeable-battery is very complicated, and taking the charging-discharging cycles solely as the lifetime index to describe the degradation process is obviously inaccurate and unreasonable. Therefore, it is necessary to consider taking one or a plurality of the cumulative-consumption-indicators to construct the comprehensive-lifetime-index, and then to describe the degradation process of the rechargeable-battery.

In some embodiments, wherein constructing the comprehensive-lifetime-index comprises: selecting one of the cumulative-consumption-indicators as the comprehensive-lifetime-index.

In some embodiments, wherein the cumulative-consumption-indicators comprise: an accumulated amount obtained by accumulating values of a usage-metric of the rechargeable-battery; but the cumulative-consumption-indicators do not comprise: an accumulated amount of the charging iteration, an accumulated amount of the discharging iteration, an accumulated amount of the merge of charging and discharging iteration, or an accumulated amount of the service duration.

Traditional lifetime prognosis method commonly adopts the accumulated amount of the charging iteration, the accumulated amount of the service duration, or the accumulated amount of the discharging iteration as the traditional-lifetime-indicator to describe the degradation process, thus excluding these traditional-lifetime-indicators from the optional types of cumulative-consumption-indicator can guarantee the creativity and progressiveness of the present Disclosure.

In some embodiments, wherein the cumulative-consumption-indicators further comprise: an accumulated amount of the charging-electricity-quantity, an accumulated amount of the discharging-electricity-quantity, or an accumulated amount of the merge of absolute charging and discharging electricity-quantity.

In some embodiments, wherein the cumulative-consumption-indicators further comprise: an accumulated amount of the charging-electric-work, an accumulated amount of the discharging-electric-work, or an accumulated amount of the merge of absolute charging and discharging electric-work.

In some embodiments, wherein the cumulative-consumption-indicators further comprise: an accumulated amount of the charging duration, an accumulated amount of the discharging duration, or an accumulated amount of the merge of charging and discharging duration.

In some embodiments, wherein the cumulative-consumption-indicators further comprise: an accumulated amount of the resting iteration, or an accumulated amount of the resting duration.

According to the different types of the cumulative-consumption-indicator, the optional types of usage-metric may include: the charging-electricity-quantity, the discharging-electricity-quantity, the charging-electric-work, the discharging-electric-work, the charging duration, the discharging duration, the resting iteration, the resting duration, which will not be repeated here.

Charging-electricity-quantity and discharging-electricity-quantity represent the physical meaning of electric charge, and its unit is Ah, referred to as ampere hour, and the charge of 1 Ah is the charge of 1 ampere of current energization for 1 hour. The common unit of charge is mAh, referred to as milliamp hours.

Charging-electric-work and discharging-electric-work represent the physical meaning of energy work, and its unit is kWh, referred to as kilowatt-hour, and the energy of 1 kWh is equivalent to the energy consumed by an electrical appliance with a power of 1000 watts after 1 hour of use. The common energy unit is J, referred to as Joule.

In some embodiments, wherein the process to acquire a value of one of the cumulative-consumption-indicators at a sampling time, comprise: selecting all of the historical spans or moments during a period from a production date of the rechargeable-battery to the sampling time as an accumulation-range, then selecting the usage-metric of the rechargeable-battery according to actual needs as object for accumulation, and then accumulating the values of the usage-metric within the accumulation-range to get an accumulated result, finally using the accumulated result as the value of one of the cumulative-consumption-indicators at the sampling time.

In some embodiments, wherein an alternative approach for selecting the accumulation-range, during the process to acquire the value of one of the cumulative-consumption-indicators at the sampling time, further comprises: the first viable option that selecting all of the historical spans or moments during a period from a put-into-use date of the rechargeable-battery to the sampling time as the accumulation-range, the second viable option that appointing a certain fixed time as an initial accumulation point then selecting all of the historical spans or moments during a period from the initial accumulation point to the sampling time as the accumulation-range, or the third viable option that selecting partial of the historical spans or moments during a period from the production date of the rechargeable-battery to the sampling time as the accumulation-range.

Generally speaking, in the process of obtaining the value of one of the cumulative-consumption-indicators at a specific sampling time, a straightforward example is to accumulate all the available value of the usage-metric within all of the historical spans or moments until this specific sampling time. For this straightforward example only, the selected accumulation-range would be all of the historical spans or moments within the period from the production date of the battery to this specific sampling time. However, in order to reduce the calculation amount, sampling or data compression technology, can also be used here. For example, making sparse sampling or compressive sampling on the original degradation-data (that with only partial of the historical spans or moments are selected as the accumulation-range), and then carrying out the accumulation process; for example, selecting partial of the historical spans or moments during the period from the production date of the battery to this specific sampling time and defining them as the accumulation-range, then selecting a specific usage-metric of the rechargeable-battery according to actual needs as the accumulation object, finally accumulating all the available value of this usage-metric within the selected accumulation-range and using the accumulated result as the value of this kind of cumulative-consumption-indicator at that specific sampling time. In the process to obtain the value of one of the cumulative-consumption-indicators, some other data sampling technologies can also be adopted to re-sample or re-calculate the degradation-data within accumulation-range, and it is also possible to flexibly select the accumulation-range according to actual needs, or select some other initial accumulation points for the accumulation-range according to actual needs, and the present Disclosure does not make any limitations on it.

Generally speaking, the accumulated amount of the charging-electricity-quantity represents the amount of charging-electricity-quantity that accumulatively charged into the battery during all the charging processes within the selected accumulation-range. The accumulated amount of the discharging-electricity-quantity represents the amount of discharging-electricity-quantity that accumulatively discharged out of the battery during all the discharging processes within the selected accumulation-range. To acquire the accumulated amount of the merge of absolute charging and discharging electricity-quantity, the process is to take absolute value of charging-electricity-quantity and discharging-electricity-quantity during all the charging and discharging processes within the selected accumulation-range, and then accumulate them together.

Specifically, the accumulated amount of the charging-electricity-quantity represents the amount of charging-electricity-quantity that accumulatively charged into the battery within the selected accumulation-range. For a rechargeable-battery, it will be continuously charged or discharged after it was first put into use, and the accumulated amount of the charging-electricity-quantity could be obtained by accumulating the amount of electricity charged into the battery within the selected accumulation-range. The “accumulation” here refers to the accumulation process, and the “accumulated” emphasizes the accumulated result. The accumulated amount of the charging-electric-work represents the amount of charging-electric-work that accumulatively charged into the battery during all the charging processes within the selected accumulation-range. The accumulated amount of the discharging-electric-work represents the amount of discharging-electric-work that accumulatively discharged out of the battery during all the discharging processes within the selected accumulation-range. To acquire the accumulated amount of the merge of absolute charging and discharging electric-work, the process is to take absolute value of the charging-electric-work and discharging-electric-work during all the charging and discharging processes within the selected accumulation-range, and then accumulate them together. The accumulated amount of the charging duration represents the cumulative amount of charging hours during all the charging processes within the selected accumulation-range. The accumulated amount of the discharging duration represents the cumulative amount of discharging hours during all the discharging processes within the selected accumulation-range. To acquire the accumulated amount of the merge of charging and discharging duration, the process is to take value of the charging hours and discharging hours during all the charging and discharging processes within the selected accumulation-range, and then accumulate them together.

As previous mentioned, when acquiring the value of the cumulative-consumption-indicator at a specific sampling time, the default selected accumulation-range could be all of the historical spans or moments within the period from the production date of the battery to this specific sampling time.

For a rechargeable-battery, there might have resting periods between its charging and discharging processes, ie, it is neither being charged nor being discharged. The accumulated amount of the resting iteration can be acquired by calculating the total number of the resting times within the selected accumulation-range. The accumulated amount of the resting duration represents the cumulative amount of resting hours in between all the charging and discharging processes within the selected accumulation-range.

For the accumulated amount of the charging-electricity-quantity, its value will continually grow along with the accumulation process, as long as the rechargeable-battery has been charged, discharged or used. In other words, the charging-electricity-quantity during complete or non-complete charging processes are all feasible to be accumulated. While for the accumulated amount of the resting duration, its value is completely related with the frequency and length of rest period.

Step 103, constructing, at an appropriate modelling moment, a dynamic-degradation-model for the rechargeable-battery.

The expression of “at an appropriate modelling moment” is used in the process of constructing the degradation trend, that is, the dynamic-degradation-model could be constructed (or reconstructed) at an appropriate modelling moment, according to actual needs. For example, constructing (or reconstructing) the dynamic-degradation-model regularly each time after a certain time period passes; or setting a series of time stamps in advance, and then constructing (or reconstructing) the dynamic-degradation-model each time when those time stamps are reached; or in order to reduce the times of calculation, the dynamic-degradation-model is only constructed once at the initialization phase; or a series of “events” are set, and the dynamic-degradation-model is only constructed (or reconstructed) when the “events” are triggered; or the user can take the initiative to construct (or reconstruct) the dynamic-degradation-model as required. The description here is only illustrative, and the present Disclosure does not make any limitations on it.

In some embodiments, wherein the dynamic-degradation-model is used to describe a dynamic degradation pattern of the rechargeable-battery that characterized by decay in the value of the comprehensive-lifetime-index, during a degradation process of the rechargeable-battery, as the value of the comprehensive lifetime index constantly increases.

In some embodiments, wherein constructing the health-status-index comprises: selecting one of the key-performance-indicators as the health-status-index.

In some embodiments, wherein one of the key-performance-indicators is defined as one of working performances of the rechargeable-battery, and a value of the one of the working performances will gradually decay with long-term usage of the rechargeable-battery; specifically, a value of the one of the key-performance-indicators at the sampling time is also the value of the one of the working performances at the sampling time.

The meaning of “decay” in above mentioned “decay in the value of the comprehensive-lifetime-index” lies in that, for one of the key-performance-indicators, its values might be gradually decreasing or gradually increasing during the degradation process, as results of degradation of the performance of rechargeable-batteries. For example, during the usage of rechargeable-batteries, the actual-internal-resistance may gradually increase, and excessive actual-internal-resistance will significantly affect the working performances of rechargeable-batteries. The attenuation of the actual-internal-resistance indicates the change in the actual-internal-resistance, such as the difference compared between the current state of the rechargeable-battery and when the rechargeable-battery was first put into use, or compared between the current state and rated state of the rechargeable-battery, that due to the degradation process of the rechargeable-battery. Further, the attenuation of the actual-internal-resistance includes both the attenuation of the actual-internal-resistance in the absolute sense, and also the weighted attenuation of the actual-internal-resistance in a relative sense. The weighted attenuation of the actual-internal-resistance can be obtained by dividing the attenuation of the actual-internal-resistance by the initial-internal-resistance (the internal resistance under the initial state of the rechargeable-battery, such as when the rechargeable-battery was first put into use). In addition, the rated-internal-resistance (the internal resistance under the rated state of the rechargeable-battery, such as specified by the manufacturer) can also be used as a normalizing divisor to calculate the weighted attenuation of the actual-internal-resistance.

In some embodiments, wherein the key-performance-indicators comprise: an actual-quantity-capacity, or an attenuation of the actual-quantity-capacity.

In some embodiments, wherein the key-performance-indicators further comprise: an actual-internal-resistance, or an attenuation of the actual-internal-resistance.

In some embodiments, wherein the key-performance-indicators further comprise: an actual-work-capacity, or an attenuation of the actual-work-capacity.

The key-performance-indicator is defined as one of working performances of the rechargeable-battery, and its value will gradually decay with the long-term usage of the rechargeable-battery. For example, the actual-quantity-capacity represents the charging electricity quantity limitation or the discharging electricity quantity limitation of the rechargeable-battery, which will directly affect the working performance of rechargeable-battery during actual use. During the degradation process of the rechargeable-battery, the actual-quantity-capacity will gradually decrease until the rechargeable-battery can not to work normally.

For rechargeable-batteries, they generally have rated performance values such as rated-quantity-capacity (the actual-quantity-capacity under the rated state of the rechargeable-battery, such as specified by the manufacturer) or rated-work-capacity (the actual-work-capacity under the rated state of the rechargeable-battery, such as specified by the manufacturer). Therefore, in many application scenarios, key-performance-indicators such as actual-quantity-capacity or actual-work-capacity can be normalized according to rated performance values to obtain indicators such as weighted actual-quantity-capacity or weighted actual-work-capacity in a relative sense. For example, the actual-quantity-capacity mentioned here includes the actual-quantity-capacity in the absolute sense, and also includes the weighted actual-quantity-capacity obtained by dividing the actual-quantity-capacity by the rated-quantity-capacity (carry out mathematical transformation on the actual-quantity-capacity using stable constant normalizing divisor). The meaning of “stable constant times” in the “mathematical transformation using stable constant normalizing divisor” lies in that the adopted normalizing divisor in mathematical transformation is a certain stable constant value. Here, the rated performance value is taken as an illustrative “stable constant value”, and the present Disclosure does not make further limitations on the use of other “stable constant values”. For example, the mathematical transformation operation may also be performed through using the initial-quantity-capacity as the normalizing divisor.

The attenuation of the actual-quantity-capacity indicates the change in the actual-quantity-capacity when it is compared to when the rechargeable-battery was first put into use. The attenuation of the actual-quantity-capacity here includes the attenuation of the actual-quantity-capacity in the absolute sense, such as the absolute attenuation obtained by subtracting the current actual-quantity-capacity from the initial-quantity-capacity, or the absolute attenuation obtained by subtracting the current actual-quantity-capacity from the rated-quantity-capacity, and the present Disclosure does not make any limitations on it. Further, the attenuation of the actual-quantity-capacity also includes the weighted attenuation of the actual-quantity-capacity in a relative sense, such as obtained by dividing the (previous calculated) absolute attenuation by the rated-quantity-capacity (i.e. mathematical transformation using stable constant normalizing divisor).

In some embodiments, wherein the actual-quantity-capacity comprises a maximum electricity quantity storage capacity of the rechargeable-battery in a fully charged state, which represents a charging electricity quantity limitation or a discharging electricity quantity limitation of the rechargeable-battery, and a value of the actual-quantity-capacity will gradually decay with the long-term usage of the rechargeable-battery.

In some embodiments, wherein the value of the actual-quantity-capacity comprises: an amount of the charging-electricity-quantity that can be charged into the rechargeable-battery during a complete charging process for charging the rechargeable-battery from a fully discharged state to the fully charged state, or an amount of the discharging-electricity-quantity that can be discharged out of the rechargeable-battery during a complete discharging process for discharging the rechargeable-battery from the fully charged state to the fully discharged state.

In some embodiments, wherein the actual-work-capacity comprises the maximum electric work storage capacity of the rechargeable-battery in the fully charged state, which represents a charging electric work limitation or a discharging electric work limitation of the rechargeable-battery, and a value of the actual-work-capacity will gradually decay with the long-term usage of the rechargeable-battery.

In some embodiments, wherein the value of the actual-work-capacity comprises: an amount of the charging-electric-work that can be charged into the rechargeable-battery during the complete charging process for charging the rechargeable-battery from the fully discharged state to the fully charged state; or an amount of the discharging-electric-work that can be discharged out of the rechargeable-battery during the complete discharging process for discharging the rechargeable-battery from the fully charged state to the fully discharged state.

During the process to collect the value of one of the key-performance-indicators, considering the limitation of practical collection capability, it is acceptable to collect some values of this key-performance-indicator at some moments (partial values). For example, for the actual-quantity-capacity, its value is only collectable after the battery is fully charged or fully discharged. Although it is difficult to obtain the real-time value of the actual-quantity-capacity at incomplete charging or discharging scenarios, its estimation result can be obtained according to the dynamic-degradation-model. It means that in a certain time span, the value of the actual-quantity-capacity is only accessible at several moments (only after the battery is fully charged or fully discharged). When adopting the actual-internal-resistance of rechargeable-battery as the key-performance-indicator, there might have no similar restriction, since the process to acquire the actual-internal-resistance is not limited by the complete charging or discharging scenarios, so its value can be acquired at any time. The description here is only illustrative, and the present Disclosure does not make any limitations on it.

When the actual-quantity-capacity of the rechargeable-battery is selected as the key-performance-indicator, its value can only be collected after the battery is fully charged or fully discharged, and cannot be collected after the incomplete charging or discharging process. If adopting the actual-quantity-capacity as the key-performance-indicator, then adopting the key-performance-indicator as the comprehensive-lifetime-index to descript the degradation process of the rechargeable-batteries, it is easy to ensure the consistence between complete charging-discharging scenario and incomplete charging-discharging scenario. For example, if the complete charging-discharging scenario and incomplete charging-discharging scenario are alternately performed, it is also possible to obtain or verify the values of the actual-quantity-capacity at several moments (such as just after the battery is fully charged or fully discharged), and then those accessible values of actual-quantity-capacity can be used to construct the dynamic-degradation-model. Clearly, following previous descriptions, the degradation-data obtained from the partial complete charging-discharging scenario can be used to construct the dynamic-degradation-model, and then the constructed dynamic-degradation-model can be used to estimate or predict the actual-quantity-capacity at any lifetime statuses (corresponding to different values of comprehensive-lifetime-index), no matter it is under complete charging-discharging scenario or incomplete charging-discharging scenario. The descriptions here about the construction of the dynamic-degradation-model is only illustrative, and the present Disclosure does not make any limitations on it.

In some embodiments, wherein the degradation-data comprises: performance monitoring data that are closely related to the degradation process of the rechargeable-battery.

In some embodiments, wherein constructing, at the appropriate modelling moment, the dynamic-degradation-model for the rechargeable-battery, comprise: selecting an empirical mathematical model according to actual needs, and then setting model parameters of the empirical mathematical model, and finally combining the empirical mathematical model with the model parameters as the dynamic-degradation-model; values of the model parameters can be preset in advance or be obtained by training the empirical mathematical model based on the priori-group of the degradation-data.

In some embodiments, wherein constructing, at the appropriate modelling moment, the dynamic-degradation-model for the rechargeable-battery, further comprise: selecting a neural network prognosis model according to actual needs, and then training parameters and hyperparameters of the neural network prognosis model based on the priori-group of the degradation-data, finally combining the neural network prognosis model with its parameters and hyperparameters as the dynamic-degradation-model.

The optional types of the dynamic-degradation-model include simpler models based on empirical mathematical and more complex models based on neural network. The commonly adopted models based on empirical mathematical include stochastic model, continuous time model, discrete time model, difference equation model, algebraic equation model, differential equation model, equations system model, linear model, nonlinear model, regression model, Markov chain model, random process model, etc. The neural network prognosis model is a neural network model that used as dynamic-degradation-model. The commonly adopted models based on neural network include support vector machine, deep learning network, extreme learning network, recurrent neural network, generative confrontation network, convolutional neural network, long short-term memory network, self-encoder, Boltzmann machine, and deep belief network, etc. When selecting a specific model type from the above options, it can be selected flexibly based on the actual deployment and application scenarios.

For rechargeable-batteries, the dynamic-degradation-model can be preset in advance, so that it is directly accessible at any time. In addition, the degradation pattern can also be inferred from the priori-group of the degradation-data of rechargeable-batteries, and which could be further used to construct the dynamic-degradation-model. The priori-group of the degradation-data comprise: the available-degradation-data-samples of the rechargeable-battery, or the available-degradation-data-samples of other-similar-batteries (that are similar or identical to the rechargeable-battery). The available-degradation-data-samples comprise: the degradation-data sampled in real-time (which is also the degradation-data in real-time), the degradation-data sampled at all of historical spans or moments (which is also the all of the degradation-data in history), or the degradation-data sampled at partial of the historical spans or moments (which is also the partial of the degradation-data in history). Therefore, before implementing the prognosis operation, the dynamic-degradation-model can be timely constructed based on the (historical or real-time) degradation-data of the rechargeable-battery. Besides, the dynamic-degradation-model can also be constructed after obtaining the available-degradation-data-samples of other-similar-batteries (that are similar or identical to the rechargeable-battery). For example, conducting charging-discharging experiments in advance on the other-similar-batteries to collect the degradation-data, or collecting operation data from the other-similar-batteries that are operated and used by other users. The above mentioned “other-similar-batteries” includes the rechargeable-batteries of the same model, as well as rechargeable-batteries with the same manufacturing process and material ratio, and the present Disclosure does not make any limitations on it.

Typically, for model-based methods, the prognosis procedure can be implemented at the prognosis-execution-time with only the degradation-data collected in real-time. While for machine learning methods, in order to pursue more accurate prognosis results, it might be necessary to analyze historical data, for example, using all of the degradation-data in history at all of the historical spans or moments, or using partial of the degradation-data in history at partial of the historical spans or moments. The descriptions here about the construction of the dynamic-degradation-model is only illustrative, and the present Disclosure does not make any limitations on it.

In some embodiments, wherein the priori-group of the degradation-data comprise: the available-degradation-data-samples of the rechargeable-battery, or the available-degradation-data-samples of other-similar-batteries that are similar or identical to the rechargeable-battery.

The priori-group of the degradation-data of rechargeable-batteries contains the key dynamic information of the degradation process. Therefore, it can be processed and analyzed to infer the future development of the degradation process, and finally predict the remaining lifetime. The composition of the priori-group of the degradation-data includes the available-degradation-data-samples of the rechargeable-battery. For example, in practice, the degradation pattern can be analyzed based on the degradation-data in real-time or the degradation-data in historical collected from the rechargeable-battery. At the same time, the compositions of the priori-group of the degradation-data also include the available-degradation-data-samples of other-similar-batteries (that are similar or identical to the rechargeable-battery). For example, conducting charging-discharging experiments in advance on the other-similar-batteries to collect the degradation-data, or collecting operation data from the other-similar-batteries that are operated and used by other users. The above mentioned “other-similar-batteries” includes the rechargeable-batteries of the same model, as well as rechargeable-batteries with the same manufacturing process and material ratio, and the present Disclosure does not make any limitations on it.

In some embodiments, wherein the available-degradation-data-samples comprise: degradation-data sampled in real-time, the degradation-data sampled at all of historical spans or moments, or the degradation-data sampled at partial of the historical spans or moments.

In some embodiments, wherein the degradation-data further comprises: values of one or a plurality of the cumulative-consumption-indicators, or values of one or a plurality of the key-performance-indicators.

The collecting range of the available-degradation-data-samples can also be diverse, for example, the degradation-data sampled in real-time (which is also the degradation-data in real-time), the degradation-data sampled at all of historical spans or moments (which is also the all of the degradation-data in history), or the degradation-data sampled at partial of the historical spans or moments (which is also the partial of the degradation-data in history).

Step 105, obtaining available-degradation-data-samples of the rechargeable-battery as model-inputs of the dynamic-degradation-model.

In some embodiments, wherein the lifetime prognosis method further comprising step 100A: collecting, at an appropriate collecting moment, the available-degradation-data-samples of the rechargeable-battery. FIG. 5 is a flow diagram illustrating a lifetime prognosis method for rechargeable-battery based on the cumulative-consumption-indicators according to another exemplary embodiment.

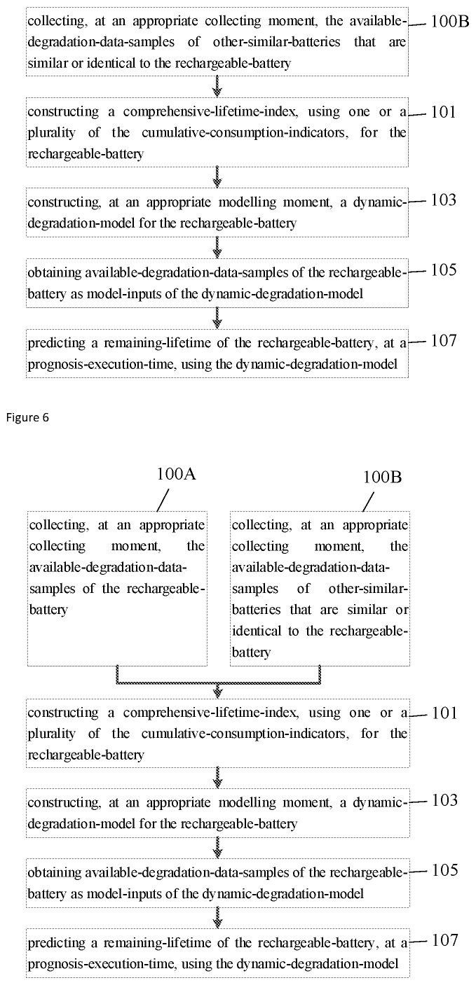

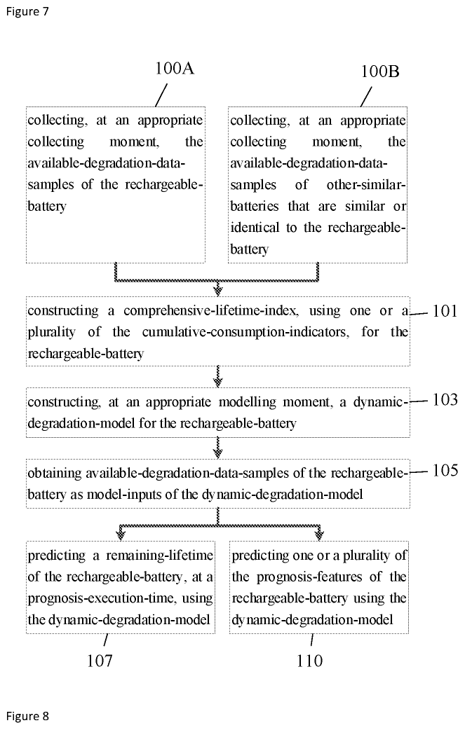

In some embodiments, wherein the lifetime prognosis method further comprising step 10013: collecting, at the appropriate collecting moment, the available-degradation-data-samples of other-similar-batteries that are similar or identical to the rechargeable-battery. FIG. 6 is a flow diagram illustrating a lifetime prognosis method for rechargeable-battery based on the cumulative-consumption-indicators according to another exemplary embodiment. FIG. 7 is a flow diagram illustrating a lifetime prognosis method for rechargeable-battery based on the cumulative-consumption-indicators according to another exemplary embodiment.

In some embodiments, wherein collecting, at the appropriate collecting moment, the available-degradation-data-samples, specifically of one of the individual batteries from the rechargeable-battery or the other-similar-batteries, comprise: the first viable option that collecting the degradation-data in real-time of the one of the individual batteries at the appropriate collecting moment, the second viable option that collecting the degradation-data in history of the one of the individual batteries at all of the historical spans or moments during a period from the production date of the one of the individual batteries to the appropriate collecting moment, or the third viable option that collecting the degradation-data in history of the one of the individual batteries at partial of the historical spans or moments during the period from the production date of the one of the individual batteries to the appropriate collecting moment.

The expression of “at the appropriate collecting moment” is used in the process of collecting the available-degradation-data-samples, that is, in the process of collecting the available-degradation-data-samples, the available-degradation-data-samples can be sampled at the appropriate collecting moment, according to actual needs. For example, sampling the available-degradation-data-samples regularly each time after a certain time period passes; or setting a series of time stamps in advance, and then sampling the available-degradation-data-samples each time when those time stamps are reached; or in order to reduce the times of calculation, the available-degradation-data-samples are only sampled once at the initialization phase; or a series of “events” are set, and the available-degradation-data-samples is only sampled when the “events” are triggered; or the user can take the initiative to sample the available-degradation-data-samples as long as it is necessary. The description here is only illustrative, and the present Disclosure does not make any limitations on it.

Step 107, predicting a remaining-lifetime of the rechargeable-battery, at a prognosis-execution-time, using the dynamic-degradation-model.

In practical applications, the prognosis process is generally executed in real-time, so that the prognosis-execution-time is usually the current moment.

In some embodiments, wherein a failure threshold is a value within feasible value range of the health-status-index of the rechargeable-battery, and the rechargeable-battery fails when a value of the health-status-index decays to the failure threshold.

In some embodiments, wherein an approach for setting the failure threshold comprise: preset the failure threshold in advance, or setting the failure threshold according to an inherent law inferred from a priori-group of the degradation-data.

The failure threshold is a value within feasible value range of the health-status-index of the rechargeable-battery, and the rechargeable-battery fails when a value of the health-status-index decays to the failure threshold. For example, if the actual-quantity-capacity (SOH) of rechargeable-battery is used as the health-status-index, the failure threshold is a value within feasible value range of the SOH. The specific value of the failure threshold can be preset in advance, for rechargeable-battery, when adopting actual-quantity-capacity (SOH) as the health-status-index, the failure threshold is commonly set as 80% of the rated-quantity-capacity (the actual-quantity-capacity under the rated state of the rechargeable-battery, such as specified by the manufacturer). The purpose of the failure threshold is used to identify the degradation degree of rechargeable-battery, commonly it is only a conservative estimation. Although the degradation degree beyond the failure threshold is unacceptable, it does not mean that the rechargeable-battery will be completely unusable at that time. The value of the failure threshold can also be flexibly set according to the actual application scenario, such as setting it according to an inherent law inferred from a priori-group of the degradation-data, and the present Disclosure does not make any limitations on it.

In some embodiments, wherein the failure-lifetime equals to a value of the comprehensive-lifetime-index when the rechargeable-battery fails; specifically, the value of the failure-lifetime is also the value of the comprehensive-lifetime-index at the time when the value of the health-status-index decays to the failure threshold.

For a rechargeable-battery, after it was put into use for continuous running, the value of its health-status-index will constantly degrade. At a certain time when the value of health-status-index of the rechargeable-battery reaches the preset failure threshold, the value of the comprehensive-lifetime-index (at the certain time) can be regarded as the failure-lifetime, that is, the value of the comprehensive-lifetime-index at the time when the rechargeable-battery fails. Specifically, the value of the failure-lifetime is also the value of the comprehensive-lifetime-index when the value of the health-status-index decays to the failure threshold.

In some embodiments, wherein the current-lifetime, at each the prognosis-execution-time, is also the value of the comprehensive-lifetime-index; specifically, the value of the current-lifetime at the prognosis-execution-time is also the value of the comprehensive-lifetime-index at the prognosis-execution-time.

In some embodiments, wherein the remaining-lifetime equals to a difference between a failure-lifetime and a current-lifetime, which represents a remaining usable amount of the comprehensive-lifetime-index before the rechargeable-battery fails; specifically, a value of the remaining-lifetime at the prognosis-execution-time is also a difference between a value of the failure-lifetime and a value of the current-lifetime at the prognosis-execution-time.

The following will take an actual case to illustrate the practical significance of remaining-lifetime, failure-lifetime, and current-lifetime at a selected prognosis-execution-time, specifically when one of the cumulative-consumption-indicators is used as the comprehensive-lifetime-index. For example, taking the accumulated amount of the charging-electricity-quantity as the comprehensive-lifetime-index, then taking the actual-quantity-capacity as the key-performance-indicator. Then for a specific rechargeable-battery, the value of its actual-quantity-capacity is set to 1000 mAh specifically when it was first put into use (which represents the initial-quantity-capacity), and the value of its failure threshold is set to 50% of the initial-quantity-capacity (which is also the 500 mAh). After a long period of running, it is assumed that the amount of charging-electricity-quantity that accumulatively charged into the battery during all the charging processes since the battery was first put into use and until the selected prognosis-execution-time has reached 400 Ah (the accumulated amount of the charging-electricity-quantity at the selected prognosis-execution-time is 400 Ah). And it is also assumed that the actual-quantity-capacity has declined from 1000 mAh to 600 mAh. In this circumstance, the current-lifetime of the rechargeable-battery is 400 Ah at the selected prognosis-execution-time, and the attenuation of the actual-quantity-capacity is 400 mAh. Further, the initial-quantity-capacity can also be used as the “stable constant normalizing divisor” in mathematical transformation process, therefore the value of 400 Ah can also be transformed into 400 times of initial-quantity-capacity. Then, after the actual-quantity-capacity of the rechargeable-battery decreases again by 100 mAh after the selected prognosis-execution-time, it will reach the failure threshold of 500 mAh. Assuming that in the degradation process, the actual-quantity-capacity decays linearly with the accumulated amount of the charging-electricity-quantity. Based on the simple mathematical model and the degradation-data in history of the rechargeable-battery, it can be predicted or concluded that if the actual-quantity-capacity of the rechargeable-battery decreases again by 100 mAh after the selected prognosis-execution-time, an additional 100 Ah of accumulated amount of the charging-electricity-quantity is needed to accumulate. Therefore, at the selected prognosis-execution-time, the prognosis result of remaining lifetime is 100 Ah, and the prognosis result of failure-lifetime is 500 Ah. The practical meaning is that the rechargeable-battery will reach its failure threshold if the value of the accumulated amount of the charging-electricity-quantity increases an additional 100 Ah after the selected prognosis-execution-time, and at that circumstance, the amount of charging-electricity-quantity that accumulatively charged into the battery is 500 Ah (since the battery was first put into use but until the failure-lifetime). The mAh represents the milliampere per hour, the Ah represents ampere per hour, and they both are capacity units. The description here about remaining-lifetime, failure-lifetime and current-lifetime is only illustrative, and the present Disclosure does not make any limitations on it. Besides, both remaining lifetime and current lifetime have relative concepts. For example, the remaining lifetime is only 20% of the failure-lifetime at the selected prognosis-execution-time, so that the relative remaining lifetime is 20%, and the relative current lifetime is 80%.

In some embodiments, wherein the rechargeable-battery in physical structure comprise: a battery individual composed by a single battery cell, a battery pack composed by multiple battery cells connected in series or parallel, or a battery cluster composed by organic integration of multiple battery cells or battery packs.

In some embodiments, wherein the rechargeable-battery in chemical structure comprise: lithium battery, lithium-ion battery, lithium-sulfur battery, sodium battery, sodium-ion battery, aluminum battery, aluminum-ion battery, graphene battery, sulfur battery, nickel-metal hydride battery, lead storage battery, all-solid-state battery, solid-liquid hybrid battery, metal battery, metal-ion battery, air battery, cylindrical battery, polymer battery, power battery, halide battery, silicon-based battery, supercapacitor, or other recyclable power storage device.

In some embodiments, wherein constructing the health-status-index comprises: using a performance feature fusion approach, with a plurality of the key-performance-indicators used as input features, to construct and output the health-status-index; specifically, using two, three, four, or a plurality of the key-performance-indicators as the input features, then the input features are organically fused using the performance feature fusion approach to form and output the health-status-index.

In some embodiments, wherein constructing the comprehensive-lifetime-index comprises: using a lifetime feature fusion approach, with a plurality of the cumulative-consumption-indicators used as the input features, to construct and output the comprehensive-lifetime-index; specifically, using two, three, four, or a plurality of the cumulative-consumption-indicators as the input features, then the input features are organically fused using the lifetime feature fusion approach to form and output the comprehensive-lifetime-index.

In some embodiments, wherein constructing the comprehensive-lifetime-index or the health-status-index using the lifetime feature fusion approach or performance feature fusion approach comprises: setting weight-coefficients for each of the input features, then weighting each of the input features according to the weight-coefficients, and finally summing up the input features to build and output the comprehensive-lifetime-index or the health-status-index; values of the weight-coefficients can be preset in advance or be obtained by training based on the priori-group of the degradation-data, but the values of the weight-coefficients corresponding to each of the input features is all non-zero, and the values of the weight-coefficients are not completely equal to each other.

The lifetime feature fusion approach is a feature fusion approach that dedicated to constructing the comprehensive-lifetime-index. The performance feature fusion approach is a feature fusion approach that dedicated to constructing the health-status-index.

In order to balance the relationship between different cumulative-consumption-indicators, the present Disclosure invents the comprehensive-lifetime-index to describe the degradation process of the rechargeable-battery. Since it is not only the number of charging-discharging cycles that be used as lifetime index, this approach is more reasonable in theory, and more flexible in reality.

The following will take a specific case to illustrate the setting of weight-coefficients and its influence on comprehensive-lifetime-index, if the comprehensive-lifetime-index is constructed through the lifetime feature fusion approach. For example, it is assumed that two cumulative-consumption-indicators of the accumulated amount of the charging duration and the accumulated amount of the discharging duration are used in the lifetime feature fusion approach to construct the comprehensive-lifetime-index, and the values of the weight-coefficients are preset in advance; then if the weight-coefficients of those two cumulative-consumption-indicators are set to be completely equal in value, the comprehensive-lifetime-index constructed through lifetime feature fusion approach will represent the physical meaning of the accumulated amount of the merge of charging and discharging duration. Still in the same example, if the weight-coefficient of the accumulated amount of the charging duration is set to zero, but the weight-coefficient of the accumulated amount of the discharging duration is not set to zero, then the comprehensive-lifetime-index constructed through lifetime feature fusion approach will still represent the physical meaning of the accumulated amount of the discharging duration. In another example, it is assumed that three cumulative-consumption-indicators of the accumulated amount of the charging duration, the accumulated amount of the discharging duration, and the accumulated amount of the resting duration are used in the lifetime feature fusion approach to construct the comprehensive-lifetime-index, and the values of the weight-coefficients are preset in advance; then if the weight-coefficients of those three cumulative-consumption-indicators are set to be completely equal, the comprehensive-lifetime-index constructed through lifetime feature fusion approach will represent the physical meaning of the accumulated amount of the service duration.

When specifying the weight-coefficients for each selected cumulative-consumption-indicators, the relationship between cumulative-consumption-indicators and weight-coefficients is one-to-one, that is, each cumulative-consumption-indicator has a corresponding weight-coefficient, and there is no dependency or correlation between different weight coefficients. In order to distinguish the present Disclosure from existing methods, the value of the weight-coefficient is further limited here, that is, the value of the weight-coefficient corresponding to different cumulative-consumption-indicators is all non-zero, and they are not completely equal to each other.

The following will take a specific case to illustrate the setting of weight-coefficients and its influence on health-status-index. For example, it is assumed that two key-performance-indicators of the actual-quantity-capacity and actual-internal-resistance are used in the performance feature fusion approach to construct the health-status-index, and the values of the weight-coefficients are preset in advance; then if the weight-coefficient of the actual-internal-resistance is set to zero, but the weight-coefficient of the actual-quantity-capacity is not set to zero, then the health-status-index constructed through performance feature fusion approach will still represent the physical meaning of the actual-internal-resistance.

When specifying the weight-coefficients for each selected key-performance-indicators, the relationship between key-performance-indicators and weight-coefficients is one-to-one, that is, each key-performance-indicator has a corresponding weight-coefficient, and there is no dependency or correlation between different weight coefficients. In order to distinguish the present Disclosure from existing methods, the value of the weight-coefficient is further limited here, that is, the value of the weight-coefficient corresponding to different types of key-performance-indicators is all non-zero, and they are not completely equal to each other.

The following will take an actual case to illustrate the practical significance of remaining-lifetime, failure-lifetime, and current-lifetime at a selected prognosis-execution-time, specifically when the comprehensive-lifetime-index is constructed through the lifetime feature fusion approach. For example, it is assumed that two cumulative-consumption-indicators of the accumulated amount of the charging-electricity-quantity and the accumulated amount of the discharging-electricity-quantity are used in the lifetime feature fusion approach to construct the comprehensive-lifetime-index, and the values of the weight-coefficients are preset in advance. For the two cumulative-consumption-indicators of the accumulated amount of the charging-electricity-quantity and the accumulated amount of the discharging-electricity-quantity, their corresponding usage-metrics are “charging-electricity-quantity” and “discharging-electricity-quantity” and they both are adopted in absolute value. Taking one of the simplest lifetime feature fusion approach as an example, assuming the weight coefficients of two cumulative-consumption-indicators (of the accumulated amount of the charging-electricity-quantity and the accumulated amount of the discharging-electricity-quantity) are both equal to 1, and then those two selected cumulative-consumption-indicators are weighted according to their corresponding weight coefficients, after that the weighted cumulative-consumption-indicators are summed up to construct the comprehensive-lifetime-index. For the constructed comprehensive-lifetime-index through this lifetime feature fusion approach, its physical meaning will represent the accumulated amount of the merge of absolute charging and discharging electricity-quantity (and the unit of this comprehensive-lifetime-index is still Ah), which already be specifically defined as an optional type of the cumulative-consumption-indicators. Because the two weight coefficients of the accumulated amount of the charging-electricity-quantity and the accumulated amount of the discharging-electricity-quantity are equal, therefore the feature fusion process will finally output the comprehensive-lifetime-index that the same with the accumulated amount of the merge of absolute charging and discharging electricity-quantity. Then, the actual-quantity-capacity is taken as the key-performance-indicator. With those settings about the comprehensive-lifetime-index and the key-performance-indicator, then for a specific rechargeable-battery, assume the value of its actual-quantity-capacity is set to 1000 mAh specifically when it was first put into use (which represents the initial-quantity-capacity), and the value of its failure threshold is set to 50% of the initial-quantity-capacity (which is also the 500 mAh). Then after a long period of running, it is assumed that the value of the comprehensive-lifetime-index is 400 Ah at the selected prognosis-execution-time, and the actual-quantity-capacity has declined from 1000 mAh to 600 mAh. In this circumstance, the current-lifetime of the rechargeable-battery is 400 Ah at the selected prognosis-execution-time, and the attenuation of the actual-quantity-capacity is 400 mAh. Then, after the actual-quantity-capacity of the rechargeable-battery decreases again by 100 mAh after the selected prognosis-execution-time, it will reach the failure threshold of 500 mAh. Assuming that in the degradation process, the actual-quantity-capacity decays linearly with the comprehensive-lifetime-index. Based on the simple mathematical model and the degradation-data in history of the rechargeable-battery, it can be predicted or concluded that if the actual-quantity-capacity of the rechargeable-battery decreases again by 100 mAh after the selected prognosis-execution-time, the value of the comprehensive-lifetime-index will increase an additional 100 Ah. Therefore, at the selected prognosis-execution-time, the prognosis result of remaining lifetime is 100 Ah, and the prognosis result of failure-lifetime is 500 Ah. The practical meaning is that the rechargeable-battery will reach its failure threshold if the value of the comprehensive-lifetime-index increases an additional 100 Ah after the selected prognosis-execution-time, and at that circumstance, the value of the comprehensive-lifetime-index would be 500 Ah at the failure-lifetime. The mAh represents the milliampere per hour, the Ah represents ampere per hour, and they both are capacity units. The description here about remaining-lifetime, failure-lifetime and current-lifetime is only illustrative, and the present Disclosure does not make any limitations on it. Besides, both remaining lifetime and current lifetime have relative concepts. For example, the remaining lifetime is only 20% of the failure-lifetime at the selected prognosis-execution-time, so that the relative remaining lifetime is 20%, and the relative current lifetime is 80%. In this specific example, the value of the comprehensive-lifetime-index at the selected prognosis-execution-time is 400 Ah; that is, the result after summing up the weighted accumulated amount of the charging-electricity-quantity and the weighted accumulated amount of the discharging-electricity-quantity through lifetime feature fusion approach is 400 Ah (at the selected prognosis-execution-time). Further, the value of 400 Ah can also be transformed into 400 times of initial-quantity-capacity when using the initial-quantity-capacity (1000 mAh) as the “stable constant normalizing divisor” in mathematical transformation process.

In some embodiments, wherein constructing the comprehensive-lifetime-index or the health-status-index using the lifetime feature fusion approach or performance feature fusion approach further comprises: selecting a neural network feature model to process the input features, then taking the output of the neural network feature model as the comprehensive-lifetime-index or the health-status-index; the neural network feature model with its parameters and hyperparameters can be preset in advance or be obtained by training based on the priori-group of the degradation-data.

The neural network feature model is a neural network model that dedicated to process the input features, for constructing the comprehensive-lifetime-index or the health-status-index, in the lifetime feature fusion approach or performance feature fusion approach.

In some embodiments, wherein a function of the dynamic-degradation-model further comprises: be able to predict one or a plurality of prognosis-features of the rechargeable-battery.

In some embodiments, wherein the lifetime prognosis method further comprising step 110: predicting one or a plurality of the prognosis-features of the rechargeable-battery using the dynamic-degradation-model. FIG. 8 is a flow diagram illustrating a lifetime prognosis method for rechargeable-battery based on the cumulative-consumption-indicators according to another exemplary embodiment.

In some embodiments, wherein the prognosis-features comprise: an optimal planned maintenance time, an optimal planned replacement time, the failure-lifetime, the current-lifetime, a relative remaining-lifetime, or a relative current-lifetime.

In some embodiments, wherein the relative remaining-lifetime comprises a ratio of the remaining-lifetime to the failure-lifetime; wherein the relative current-lifetime comprises a ratio of the current-lifetime to the failure-lifetime.

The purpose of predict the optimal planned maintenance time or the optimal planned replacement time by the lifetime prognosis method is to timely remind users before the battery fails. For example, when the predicted remaining lifetime is insufficient, the user will be reminded to replace the rechargeable-battery in time. Or, directly calculating the optimal planned replacement time in advance and to guide user to take effective measures in time.

In some embodiments, wherein the prognosis-features further comprise: a remaining-cumulable-amount of one of the cumulative-consumption-indicators before the rechargeable-battery fails, the value of one of the cumulative-consumption-indicators when the rechargeable-battery fails, future-dynamics between the health-status-index and the comprehensive-lifetime-index, future-dynamics between one of the key-performance-indicators and the comprehensive-lifetime-index, future-dynamics between one of the cumulative-consumption-indicators and the health-status-index, or future-dynamics between one of the cumulative-consumption-indicators and one of the key-performance-indicators.

Referring to the previous definitions about the comprehensive-lifetime-index, similar definitions can also be set for one of the cumulative-consumption-indicators. For example, the value of one of the cumulative-consumption-indicators, at each the prognosis-execution-time, can also be regarded as the current-cumulated-amount at each the prognosis-execution-time. Then the value of one of the cumulative-consumption-indicators at the time when the rechargeable-battery fails would represent the failure-cumulable-amount. After that the difference between the failure-cumulable-amount and the current-cumulated-amount would represent the remaining-cumulable-amount, specifically the remaining-cumulable-amount of one of the cumulative-consumption-indicators before the rechargeable-battery fails. In other words, the value of the remaining-cumulable-amount at a certain moment, of one of the cumulative-consumption-indicators, is also the difference between the value of the failure-cumulable-amount and the current-cumulated-amount at that moment.

In some embodiments, wherein the future-dynamics between the health-status-index and the comprehensive-lifetime-index comprise: within a future-lifetime-range starting from the prognosis-execution-time for future running of the rechargeable-battery, corresponding values of the health-status-index when the comprehensive-lifetime-index takes different values, or corresponding values of the comprehensive-lifetime-index when the health-status-index takes different values.

With continuous usage of the rechargeable-battery, the value of one or a plurality of the cumulative-consumption-indicators will constantly increase, and the value of the comprehensive-lifetime-index will also increase if one of the cumulative-consumption-indicators is used directly as the comprehensive-lifetime-index. Further, this will make one or a plurality of the cumulative-consumption-indicators very suitable to be used to construct the comprehensive-lifetime-index. In the future running progress, the rechargeable-battery will be continuously used for charging or discharging as long as it is not failed, and the value of one or a plurality of the cumulative-consumption-indicators will constantly increase, so that the value of the comprehensive-lifetime-index (constructed using one or a plurality of the cumulative-consumption-indicators) will also constantly increase. According this, it is possible and meaningful to predict the future-dynamics between the health-status-index and the comprehensive-lifetime-index. Wherein the future-dynamics between the health-status-index and the comprehensive-lifetime-index comprise: within the future-lifetime-range starting from the prognosis-execution-time for future running of the rechargeable-battery, the corresponding values of the health-status-index when the comprehensive-lifetime-index takes different values, or the corresponding values of the comprehensive-lifetime-index when the health-status-index takes different values. The description of “takes different values” is used here, thus it is possible to predict multiple values of the health-status-index (corresponding to different values of the comprehensive-lifetime-index), as long as those different values of the comprehensive-lifetime-index are within the future-lifetime-range. Similarly, vice versa for predicting multiple values of the comprehensive-lifetime-index.

In some embodiments, wherein the future-dynamics between one of the key-performance-indicators and the comprehensive-lifetime-index comprise: within the future-lifetime-range starting from the prognosis-execution-time for future running of the rechargeable-battery, corresponding values of one of the key-performance-indicators when the comprehensive-lifetime-index takes different values, or the corresponding values of the comprehensive-lifetime-index when one of the key-performance-indicators takes different values.

In some embodiments, wherein the future-dynamics between one of the cumulative-consumption-indicators and the health-status-index comprise: within the future-lifetime-range starting from the prognosis-execution-time for future running of the rechargeable-battery, corresponding values of one of the cumulative-consumption-indicators when the health-status-index takes different values, or the corresponding values of the health-status-index when one of the cumulative-consumption-indicators takes different values.

In some embodiments, wherein the future-dynamics between one of the cumulative-consumption-indicators and one of the key-performance-indicators comprise: within the future-lifetime-range starting from the prognosis-execution-time for future running of the rechargeable-battery, the corresponding values of one of the key-performance-indicators when one of the cumulative-consumption-indicators takes different values, or the corresponding values of one of the cumulative-consumption-indicators when one of the key-performance-indicators takes different values.

It is also very meaningful to predict the remaining-cumulable-amount of one of the cumulative-consumption-indicators before the rechargeable-battery fails, therefore the steps of the present Disclosure also include predicting the remaining-cumulable-amount of one of the cumulative-consumption-indicators before the rechargeable-battery fails, such as the remaining-cumulable-amount of the charging-electric-work (specifically the remaining-cumulable-amount of the charging-electric-work before the rechargeable-battery fails), the remaining-cumulable-amount of the charging duration (specifically the remaining-cumulable-amount of the charging duration before the rechargeable-battery fails). Besides, it is also possible for the present Disclosure to predict the value of one of the cumulative-consumption-indicators when the rechargeable-battery fails, such as the failure-cumulable-amount of charging-electric-work (specifically the value of the accumulated amount of the charging-electric-work at the time when the rechargeable-battery fails), the failure-cumulable-amount of charging duration (specifically the value of the accumulated amount of the charging duration at the time when the rechargeable-battery fails).

For example, it is possible for the present Disclosure to predict the remaining-lifetime of the rechargeable-battery according to Step 107, which is also the remaining usable amount of the comprehensive-lifetime-index before the rechargeable-battery fails, and then the predicted remaining-lifetime can be further converted into the remaining-cumulable-amount of one or a plurality of the cumulative-consumption-indicators, according to the general relationship between the comprehensive-lifetime-index and one or a plurality of the cumulative-consumption-indicators (such as inferred from the priori-group of the degradation-data or the pre-established future utilization planning).

For example, if the accumulated amount of the discharging-electric-work is not adopted as the comprehensive-lifetime-index, while it is still necessary to predict and acquire the estimation result of the remaining-cumulable-amount of the charging-electric-work; the technical solution would be to analysis the general relationship between the comprehensive-lifetime-index and the accumulated amount of the discharging-electric-work, and then predict the remaining-lifetime of the rechargeable-battery according to Step 107, which is also the remaining usable amount of the comprehensive-lifetime-index before the rechargeable-battery fails, and finally transform the remaining-lifetime (of the comprehensive-lifetime-index) into the remaining-cumulable-amount (of discharging-electric-work), according to the acquired general relationship between the comprehensive-lifetime-index and the accumulated amount of the discharging-electric-work. In another example, if the accumulated amount of the merge of charging and discharging duration is not adopted as the comprehensive-lifetime-index, while it is still necessary to predict and acquire the estimation result of the remaining-cumulable-amount the merge of charging and discharging duration; the technical solution would be to analysis the general relationship between the comprehensive-lifetime-index and the accumulated amount of the merge of charging and discharging duration, and then predict the remaining-lifetime of the rechargeable-battery according to Step 107, which is also the remaining usable amount of the comprehensive-lifetime-index before the rechargeable-battery fails, and finally transform the remaining-lifetime (of the comprehensive-lifetime-index) into the remaining-cumulable-amount (of the merge of charging and discharging duration), according to the acquired general relationship between the comprehensive-lifetime-index and the accumulated amount of the merge of charging and discharging duration. The description here is only illustrative, and the present Disclosure does not make any limitations on it. If it is necessary to obtain the remaining-cumulable-amount of any other cumulative-consumption-indicator, a similar operation can also be used by referring to the above introduction.

In some embodiments, wherein the degradation-data further comprises: values of one or a plurality of operating-conditions; generally, changes in value of one or a plurality of the operating-conditions may affect the working performances of the rechargeable-battery in use, and then may affect the dynamic degradation pattern of the rechargeable-battery.

In some embodiments, wherein the operating-conditions comprise: changes in value of a battery terminal voltage, changes in value of a battery terminal current, changes in value of a battery terminal power, changes in value of a battery body temperature, or changes in value of an external environment temperature, within each of charging processes or each of discharging processes of the rechargeable-battery.

In some embodiments, wherein the operating-conditions further comprise: mean average of the battery terminal voltage, mean average of the battery terminal current, mean average of the battery terminal power, mean average of the battery body temperature, or mean average of the external environment temperature, within each of the charging processes or each of the discharging processes of the rechargeable-battery.

In some embodiments, wherein the operating-conditions further comprise: charging cut-off current of the rechargeable-battery in each of the charging processes, or discharging cut-off voltage of the rechargeable-battery in each of the discharging processes; the charging cut-off current refers to a preset current limit at which the rechargeable-battery should not continue to charge when the battery terminal current drops to this preset current limit during each of the charging processes; the discharging cut-off voltage refers to a preset voltage limit at which the rechargeable-battery should not continue to discharge when the battery terminal voltage drops to this preset voltage limit during each of the discharging processes.

For the rechargeable-battery, the settings of one or a plurality of the operating-conditions clearly will affect its working performances, and may further affect its degradation processes. For the running of the rechargeable-battery, operating or setting parameters such as battery terminal voltage, battery terminal current, battery terminal power, battery body temperature, external environment temperature, etc. might be different during each of the charging processes or each of the discharging processes. The changing dynamics of each operating or setting parameters would have direct and immediate impact on the performance of the rechargeable-battery; thus, they can be regarded as the operating-conditions of the rechargeable-battery. In addition, in order to simplify the analysis and calculation, the changing dynamics of each operating or setting parameters can also be averaged for each charge or discharging process and then be regarded as the operating-conditions of the rechargeable-battery.

The battery terminal voltage refers to the voltage between the positive and negative poles of the rechargeable-battery during running process; the battery terminal current refers to the current between the positive and negative poles of the rechargeable-battery during running process; the battery terminal power refers to the power between the positive and negative poles of the rechargeable-battery during running process; the battery body temperature is the actual temperature of the rechargeable-battery body, which can be obtained by setting a temperature sensor on the surface or inside of the rechargeable-battery. The external ambient temperature is the temperature of the environment where the rechargeable-battery runs. For the battery powered equipment in outdoor, the external environment temperature can be directly acquired from the meteorological observation data, and the future-dynamics of external environment temperature can also be obtained through the weather forecast.

Firstly, the external environment temperature is taken as an example to illustrate the impact of the operating-conditions on the working performances of rechargeable-batteries. It is widely known that the sudden drop of the external environment temperature will seriously affect the working performances of rechargeable-batteries. For instance, in the cold winter at the high-latitude of Northern Hemisphere, the news that electric vehicles breaking down and causing traffic congestion is nothing new now. Even if two new batteries have the same specification, their working performance in different environmental temperatures will vary significantly. Therefore, in practical use, significant changes in environmental temperature can lead to significant changes in the actual storage capacity of the battery.

In addition, in the practical application of the rechargeable-battery, the battery terminal current will also change (such as due to human intervention). The change of the battery terminal current could change the battery terminal power of the rechargeable-battery, and further will significantly affect the working performances of the battery powered equipment. For electric vehicles, the speed of electric vehicles can be significantly increased by increasing the battery terminal current of rechargeable-battery, but this will cause extra energy loss due to the actual-internal-resistance of the rechargeable-battery, and thus significantly affect the value of the actual-quantity-capacity. For a rechargeable-battery with a specific actual-internal-resistance, differences in the battery terminal current will result in differences in the battery terminal voltage (and the rechargeable battery will become non-dischargeable if the battery terminal voltage falls below the discharging cut-off voltage during each of the discharging processes), and this will in turn cause significant differences in the value of the actual-quantity-capacity; and this situation is similar for two new batteries with the same specification. In short, the settings of the battery terminal current will have significant impact on the value of actual-quantity-capacity. In addition, changes in operating-conditions may also affect other working performances of rechargeable-batteries (such as actual-internal-resistance, actual-work-capacity, etc.), which will not be repeated here.

The magnitude of the battery terminal current (of a rechargeable battery) can be represented by either the actual current value (in unit of in A or mA), or by the charging-discharging rate (in units of C-rate). The charging-discharging rate (in units of C-rate) can be acquired after carrying out mathematical transformation on the actual current value (in unit of in A or mA) using a stable constant normalizing divisor (commonly equals to the rated-quantity-capacity). All in all, both unit of C, A and mA have the physical meaning of current and all can be regarded as a physical property of current here.

For a complete charging process adopting the constant current and constant voltage profile, if the absolute value of the charging cut-off current is set to be very large (in constant voltage charging stage), the charging-electricity-quantity that can be charged into the rechargeable-battery during the complete charging process will be very small, and further resulting a reduced actual-quantity-capacity, so that the setting of the charging cut-off current would influence the value of the actual-quantity-capacity. While for a complete discharging process, if the absolute value of the discharging cut-off voltage is set to be very large, the discharging-electricity-quantity that can be discharged out of the rechargeable-battery during the complete discharging process will be very small, which means that it would be very hard for the rechargeable-battery to release its stored energy, so that the setting of the discharging cut-off voltage would also influence the value of the actual-quantity-capacity.

In some embodiments, wherein the key-performance-indicators further comprise: one or a plurality of the cumulative-consumption-indicators.

In the present Disclosure, one or a plurality of the cumulative-consumption-indicators can also be regarded as (the optional types of) the key-performance-indicators. Then in the process of constructing the health-status-index, one or a plurality of the cumulative-consumption-indicators can also be selected as (the optional types of) the input features, according to actual needs, to be used in the performance feature fusion approach to construct and output the health-status-index.

In some embodiments, wherein the function of the dynamic-degradation-model further comprises: be able to consider influence of the operating-conditions on the dynamic degradation pattern of the rechargeable-battery.

In some embodiments, wherein predicting the remaining-lifetime of the rechargeable-battery further comprises: considering influence of future-operating-conditions on the dynamic degradation pattern of the rechargeable-battery, then adopting estimation results of the future-operating-conditions of the rechargeable-battery as additional model-inputs of the dynamic-degradation-model, finally using the dynamic-degradation-model to predict the remaining-lifetime of the rechargeable-battery.

In some embodiments, wherein predicting one or a plurality of the prognosis-features of the rechargeable-battery further comprises: considering influence of future-operating-conditions on the dynamic degradation pattern of the rechargeable-battery, then adopting estimation results of the future-operating-conditions of the rechargeable-battery as the additional model-inputs of the dynamic-degradation-model, finally using the dynamic-degradation-model to predict one or a plurality of the prognosis-features of the rechargeable-battery.

In the present Disclosure, it is possible for the dynamic-degradation-model to take the influence of the operating-conditions into account, and the future-operating-conditions are needed to be used as additional model-inputs of the dynamic-degradation-model during the prognosis process. Therefore, it is necessary to estimate future-operating-conditions of the rechargeable-battery.

In some embodiments, wherein the future-operating-conditions comprise: the values of one or a plurality of the operating-conditions within the future-lifetime-range starting from the prognosis-execution-time for future running of the rechargeable-battery.

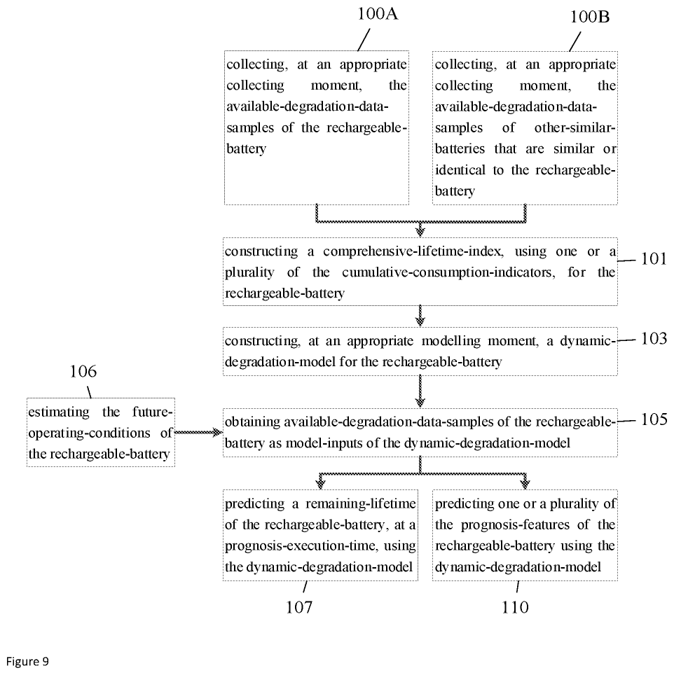

In some embodiments, wherein the lifetime prognosis method further comprising step 106: estimating the future-operating-conditions of the rechargeable-battery. FIG. 9 is a flow diagram illustrating a lifetime prognosis method for rechargeable-battery based on the cumulative-consumption-indicators according to another exemplary embodiment.

In some embodiments, wherein a condition estimation approach for estimating the future-operating-conditions of the rechargeable-battery comprises: the first viable option that estimating the future-operating-conditions of the rechargeable-battery according to a pre-established future utilization planning, or the second viable option that estimating the future-operating-conditions of the rechargeable-battery according to inherent changing patterns of the operating-conditions that can be inferred from the priori-group of the degradation-data.

In some application scenarios, the future running of the rechargeable-battery would follow the pre-established future utilization planning, so that the future-operating-conditions of the rechargeable-battery can be accurately acquired according to the pre-established future utilization planning. In some other application scenarios, the operating-conditions of the rechargeable-battery would have its inherent changing patterns, and it could be possible to infer these inherent changing patterns according to the historical running process of rechargeable-battery. More specifically, it might be possible to explore or infer these inherent changing patterns according to the priori-group of the degradation-data of the rechargeable-battery, and then make accurate estimation of the future-operating-conditions of the rechargeable-battery. For example, making such estimation according to the inherent changing patterns of the operating-conditions that can be inferred from the available-degradation-data-samples of the rechargeable-battery, or making such estimation according to inherent changing patterns of the operating-conditions that can be inferred from the available-degradation-data-samples of other-similar-batteries (that are similar or identical to the rechargeable-battery).

In some embodiments, wherein estimating the future-operating-conditions of the rechargeable-battery further comprises: the first viable option that assuming the values of one or a plurality of the operating-conditions will change with time during the future-lifetime-range and then using the condition estimation approach to estimate changing dynamics of one or a plurality of the operating-conditions over the future-lifetime-range, or the second viable option that assuming the values of one or a plurality of the operating-conditions will remain stable during the future-lifetime-range and then using the condition estimation approach to estimate mean values of one or a plurality of the operating-conditions over the future-lifetime-range.

In some cases that with no high accuracy requirements, the estimation of the future-operating-conditions can also be simplified, such as assuming each of the related operation-conditions would remain stable during the future-lifetime-range, and then estimate the mean value for each of the related operation-conditions as the approximate equivalent of future-operating-conditions. The description here is only illustrative, and the present Disclosure does not make any limitations on it.

In some embodiments, wherein accumulating the values of the usage-metric within the accumulation-range to get an accumulated result, during the process to acquire the value of one of the cumulative-consumption-indicators at the sampling time, further comprise: accumulating, considering impacts of one or a plurality of the operating-conditions, the values of the usage-metric within the accumulation-range to get an accumulated result; wherein accumulating, considering the impacts of one or a plurality of the operating-conditions, the values of the usage-metric within the accumulation-range to get an accumulated result, comprise: obtaining the values of one or a plurality of the operating-conditions at each time within the accumulation-range, then generating values of weighted-coefficient for the values of one or a plurality of the operating-conditions at each time within the accumulation-range according to specific models or rules, and then obtaining values of weighted usage-metric at each time within the accumulation-range by multiplying the values of the usage-metric and the values of the weighted-coefficient at each time within the accumulation-range, and then accumulating the values of the weighted usage-metric over the accumulation-range to get the accumulated result, finally using the accumulated result as the value of one of the cumulative-consumption-indicators at the sampling time; the specific models or rules can be obtained by training based on the priori-group of the degradation-data or can be preset in advance.

In some embodiments, wherein the cumulative-consumption-indicators, under the precondition of considering the impacts of one or a plurality of the operating-conditions when accumulating the values of the usage-metric within the accumulation-range to get an accumulated result, further comprise: the accumulated amount of the charging iteration, the accumulated amount of the discharging iteration, the accumulated amount of the merge of charging and discharging iteration, or the accumulated amount of the service duration.

Traditional lifetime prognosis method commonly adopts the accumulated amount of the charging iteration, the accumulated amount of the discharging iteration, or the accumulated amount of the service duration as the traditional-lifetime-indicator to describe the degradation process, but those traditional-lifetime-indicators just make simply accumulation of a certain usage-metric, such as the charging iteration, the discharging iteration, the merge of charging and discharging iteration, or the service duration, and have not considered the influence of the operating-conditions in the accumulation process. Therefore, in some embodiments of the present Disclosure, one or a plurality of the traditional-lifetime-indicators can also be regarded as the cumulative-consumption-indicators, but the prerequisite is that the influence of one or more operating-conditions needed to be considered in the accumulation process, which could guarantee the creativity and progressiveness of the present Disclosure.

The meaning of considering the impacts of the operating-conditions during the constructing process of one of the cumulative-consumption-indicators lies in that the difference in operation conditions might introduce the difference in actual consumption of rechargeable-battery. For example, when using a relatively higher battery terminal current on the rechargeable battery, compared to the rated battery terminal current, it may cause additional damage to the internal structure of the battery. Thus, in the process of constructing the cumulative-consumption-indicator, the impacts of one or a plurality of the operating-conditions can also be considered. The following takes a practical example to illustrate the practical meaning of this setting. First of all, it is assumed that a series of discharging currents (of 1 A, 2 A and 0.5 A) would be adopted, in the discharging processes of a certain rechargeable-battery with a rated capacity of 1 Ah. To simplify further discussion, assuming only the impact of one of the the operating-conditions is considered during the constructing process of one of the cumulative-consumption-indicators. Specifically, the accumulated amount of the discharging-electricity-quantity is used as the cumulative-consumption-indicator and also used as the comprehensive-lifetime-index, and the impact of different discharging currents is considered in the constructing process of the accumulated amount of the discharging-electricity-quantity. Further, the relationship between the weighted-coefficients and the discharging currents is described using a simple positive proportion function, so that the weighted-coefficients can be generated according to the positive proportion function and the values of the discharging current. Specifically, a series of weighted-coefficients are generated for different discharging currents. For example, letting the weighted-coefficient for 1 A is 1, letting the weighted-coefficient for 2 A is 2, letting the weighted-coefficient for 0.5 A is 0.5. After that, the accumulation process for constructing the cumulative-consumption-indicator is based on the values of the weighted usage-metric that obtained by multiplying the values of the usage-metric by the weighted-coefficient. For example, after using 2 A current to discharge for a period of 30 minutes, the absolutely accumulated amount of the discharging-electricity-quantity in this period would be 1 Ah, while the weighted accumulated amount of the discharging-electricity-quantity in this period would be 2 Ah (using absolutely accumulated amount of the discharging-electricity-quantity of 1 Ah multiply the weighted-coefficient of 2); then after using 0.5 A current to discharge for a period of 2 hours, the absolutely accumulated amount of the discharging-electricity-quantity in this period would still be 1 Ah, while the weighted accumulated amount of the discharging-electricity-quantity in this period would be 0.5 Ah (using absolutely accumulated amount of the discharging-electricity-quantity of 1 Ah multiply the weighted-coefficient of 0.5). Clearly, in this example, the value of the comprehensive-lifetime-index of the rechargeable-battery will increase faster if a larger current is used for discharging, and that also means that the consumption of the lifetime of the rechargeable-battery will be faster if a larger discharging current is used.

In previous practical example of considering the impacts of the operating-conditions during the constructing process of one of the cumulative-consumption-indicators, the approach to generate the weighted-coefficients for different discharging currents is relatively simple, without considering the influence of time-varying function of one of the operating-conditions or the coupling function of a plurality of operating-conditions, and some complex functions such as square and exponential are also not considered. But it is also possible to generate the weighted-coefficients according to square relation, such as using a square function to describe the weighted-coefficients and the discharging currents, and using the square of the values of the discharging current to generate the weighted-coefficients. For example, letting the weighted-coefficient for 1 A is 1, letting the weighted-coefficient for 2 A is 4, letting the weighted-coefficient for 0.5 A is 0.25. After that, the accumulation process for constructing the cumulative-consumption-indicator is based on the values of the weighted usage-metric that obtained by multiplying the values of the usage-metric by the weighted-coefficient. For example, after using 2 A current to discharge for a period of 30 minutes, the absolutely accumulated amount of the discharging-electricity-quantity in this period would be 1 Ah, while the weighted accumulated amount of the discharging-electricity-quantity in this period would be 4 Ah (using absolutely accumulated amount of the discharging-electricity-quantity of 1 Ah multiply the weighted-coefficient of 4); then after using 0.5 A current to discharge for a period of 2 hours, the absolutely accumulated amount of the discharging-electricity-quantity in this period would still be 1 Ah, while the weighted accumulated amount of the discharging-electricity-quantity in this period would be 0.25 Ah (using absolutely accumulated amount of the discharging-electricity-quantity of 1 Ah multiply the weighted-coefficient of 0.25).

In addition, in some scenarios, the rules, functions, or models used to generate the weighted-coefficients according to values of one of the operating-conditions might be time varying. For example, using the positive proportion function to generate the weighted-coefficients within a certain time period, while in another time period, the weighted-coefficients are generated by the square function. In addition, more complex methods such as neural network models or empirical mathematical models can also be used to generate the weighted-coefficients, and further, the weighted-coefficients can also be generated according to the coupling function of a plurality of operating-conditions, which will not be repeated here.

In some embodiments, wherein the cumulative-consumption-indicators further comprise: an accumulated amount of the actual workload generated by the battery powered equipment, an accumulated amount of the actual work generated by the battery powered equipment, or an accumulated amount of the actual mileage generated by the battery powered vehicle;

In some embodiments, wherein the key-performance-indicators further comprise: an actual workload generated by the battery powered equipment by discharging the rechargeable-battery from the fully charged state to the fully discharged state, an actual work generated by the battery powered equipment by discharging the rechargeable-battery from the fully charged state to the fully discharged state, or an actual mileage generated by the battery powered vehicle by discharging the rechargeable-battery from the fully charged state to the fully discharged state.

For some battery powered equipment (that directly derived by the rechargeable-battery), its working ability is closely related to the working performances (such as the actual-quantity-capacity) of the rechargeable-battery. Besides, in some circumstances, the rechargeable-battery might be irreversibly and permanently integrated with the battery powered equipment, so that the usage-metric of battery powered equipment could be much more accessible than the usage-metric of rechargeable-battery. Therefore, the working performances of the battery powered equipment can be regarded as (the optional types of) the key-performance-indicator, and further to be used to construct the health-status-index. Similarly, the accumulated amount obtained by accumulating values of a usage-metric of the battery powered equipment can be regarded as (the optional types of) the cumulative-consumption-indicator, and further to be used to construct the comprehensive-lifetime-index.

For the battery powered vehicle, its usage-metric can be defined by its actual mileage (the mileage it has traveled). For battery powered equipment, its usage-metric can be defined by its actual work (the work it has done), including mechanical work, electrical work, thermal energy and other different types of generated energy. For example, for a portable hand warmer, its actual work could be defined by the quantity of heat it has generated. For a portable electric drill, its actual work could be defined by the quantity of mechanical work it has generated. Besides, for battery powered equipment, its usage-metric can also be defined by its actual workload (the workload it has done). For example, for a sweeping robot, its actual workload could be defined by the weight or quantity of garbage it has handled. For the data center, its actual workload could be defined by the quantity of data bytes it has stored or retrieved. For a portable computer, its actual workload could be defined by the number of instruction lines it has processed. For an electric shaver, its actual workload could be defined by the number of rotations its blade has rotated. The description here is only illustrative, and the present Disclosure does not make any limitations on it.

Taking the battery powered vehicle as an example, the key-performance-indicator could be the actual mileage generated by the battery powered vehicle by discharging the rechargeable-battery from the fully charged state to the fully discharged state, and the cumulative-consumption-indicator could be the accumulated amount of actual mileage generated by the battery powered vehicle within the selected accumulation-range; then taking the electric drill as another example, the key-performance-indicator could be the actual (mechanical) work generated by the battery powered equipment by discharging the rechargeable-battery from the fully charged state to the fully discharged state, and the cumulative-consumption-indicator could be the accumulated amount of actual (mechanical) work generated by the operation of the battery powered equipment within the selected accumulation-range. The description here is only illustrative, and the present Disclosure does not make any limitations on it. Those related indicators can also be converted into normalized indicators through the mathematical transformation with some rated values used as the stable constant normalizing divisor.

In some embodiments, wherein the operating-conditions further comprise: changes in value of an operating-power of the battery powered equipment within each of the charging processes or each of the discharging processes, or mean average of the operating-power of the battery powered equipment within each of the charging processes or each of the discharging processes.

In some embodiments, wherein the operating-conditions further comprise: changes in value of a production-efficiency of the battery powered equipment within each of the charging processes or each of the discharging processes, or mean average of the production-efficiency of the battery powered equipment within each of the charging processes or each of the discharging processes.

In some embodiments, wherein the operating-conditions further comprise: changes in value of a driving speed of the battery powered vehicle within each of driving processes, or mean average of the driving speed of the battery powered vehicle within each of the driving processes.

The production-efficiency represents the workload that can be generated by the battery powered equipment during each unit of time; the operating-power represents the work that can be generated by the battery powered equipment during each unit of time; the driving speed represents the mileage that can be generated by the battery powered vehicle during each unit of time.

When rechargeable-battery is adopted to support the running of the battery powered equipment, the operating-conditions can be flexibly selected according to the actual situation. For example, for battery powered equipment, its operating-power during the running process can be regarded as the operating-condition; besides, for battery powered equipment that emphasis on production output, its production-efficiency during the running process can be regarded as the operating-condition; for the battery powered vehicle, its driving speed during travelling process can be regarded as the operating-condition; also for the battery powered vehicle, if its air conditioning function is turned on for cooling or heating, the operating-condition could be the operating-power of its whole energy system. In addition, to simplify the analysis and calculation, the changes of a certain operating-condition can also be averaged within each running process. The descriptions here about the operating-condition are only illustrative, and the present Disclosure does not make any limitations on it. Those operating-conditions can also be converted into normalized operating-conditions through mathematical transformation with some rated values used as the stable constant normalizing divisor, which will not be repeated here.

In some embodiments, wherein the cumulative-consumption-indicators further comprise: an accumulated amount of one of the operating-conditions; specifically, the process to acquire the accumulated amount of one of the operating-conditions comprise: taking one of the operating-conditions as object for accumulation, then accumulating the values of one of the operating-conditions within the accumulation-range to get the accumulated result, finally using the accumulated result as the value of one of the cumulative-consumption-indicators at the sampling time;

In some embodiments, wherein the cumulative-consumption-indicators further comprise: an accumulated amount of the weighted charging-electric-work, an accumulated amount of the weighted discharging-electric-work, or an accumulated amount of the weighted merge of absolute charging and discharging electric-work.

In some embodiments, wherein the weighted charging-electric-work comprise: a ratio of the charging-electric-work to a rated-work-capacity, a ratio of the charging-electric-work to an initial-work-capacity, or a ratio of the charging-electric-work to the actual-work-capacity; wherein the weighted discharging-electric-work comprise: a ratio of the discharging-electric-work to the rated-work-capacity, a ratio of the discharging-electric-work to the initial-work-capacity, or a ratio of the discharging-electric-work to the actual-work-capacity.

In some embodiments, wherein the cumulative-consumption-indicators further comprise: an accumulated amount of the weighted charging-electricity-quantity, an accumulated amount of the weighted discharging-electricity-quantity, or an accumulated amount of the weighted merge of absolute charging and discharging electricity-quantity.

In some embodiments, wherein the weighted charging-electricity-quantity comprise: a ratio of the charging-electricity-quantity to a rated-quantity-capacity, a ratio of the charging-electricity-quantity to an initial-quantity-capacity, or a ratio of the charging-electricity-quantity to the actual-quantity-capacity; wherein the weighted discharging-electricity-quantity comprise: a ratio of the discharging-electricity-quantity to the rated-quantity-capacity, a ratio of the discharging-electricity-quantity to the initial-quantity-capacity, or a ratio of the discharging-electricity-quantity to the actual-quantity-capacity.

One or a plurality of the cumulative-consumption-indicators mentioned above can also be converted into one or a plurality of normalized cumulative-consumption-indicators through mathematical transformation with some rated values be used as the stable constant normalizing divisor, such as making mathematical transformation on the accumulated amount of the charging-electricity-quantity, the accumulated amount of the charging-electric-work, or the accumulated amount of the charging duration. For example, in some circumstances, the accumulated amount of the weighted charging-electricity-quantity in the relative sense can be obtained by dividing the cumulative amount of the charging-electricity-quantity by the rated-quantity-capacity of the rechargeable-battery, which is a ratio factor obtained by dividing the value of the accumulated amount of the weighted charging-electricity-quantity by the rated-quantity-capacity. Then for the accumulated amount of the charging-electric-work or the accumulated amount of the charging duration, their related definitions of mathematical transformation using stable constant normalizing divisor are very similar to this.

The accumulated amount of the weighted charging-electricity-quantity represents the amount of weighted charging-electricity-quantity that accumulatively charged into the battery during all the charging processes within the selected accumulation-range. The accumulated amount of the weighted discharging-electricity-quantity represents the amount of weighted discharging-electricity-quantity that accumulatively discharged out of the battery during all the discharging processes within the selected accumulation-range. To acquire the weighted charging-electricity-quantity (or weighted discharging-electricity-quantity) generated in each charging process (or discharging process), it is necessary to obtain the absolute charging-electricity-quantity (or absolute discharging-electricity-quantity) generated in each charging process (or discharging process), and then select an appropriate rated value as the normalizing divisor to calculate the weighted charging-electricity-quantity (or weighted discharging-electricity-quantity). When the actual-quantity-capacity is used as the normalizing divisor, the value of actual-quantity-capacity needs to be obtained in real-time, since it will generally degrade during the degradation process. To acquire the accumulated amount of the weighted merge of absolute charging and discharging electricity-quantity, the process is to take absolute value of weighted charging-electricity-quantity and weighted discharging-electricity-quantity during all the charging and discharging processes within the selected accumulation-range, and then accumulate them together. As previous mentioned, when acquiring the value of one of the cumulative-consumption-indicators at a specific sampling time, the selected accumulation-range could be all of the historical spans or moments within the period from the production date of the battery to this specific sampling time.

The accumulated amount of the weighted charging-electric-work represents the amount of weighted charging-electric-work that accumulatively charged into the battery during all the charging processes within the selected accumulation-range. The accumulated amount of the weighted discharging-electric-work represents the amount of weighted discharging-electric-work that accumulatively discharged out of the battery during all the discharging processes within the selected accumulation-range. To acquire the weighted charging-electric-work (or the weighted discharging-electric-work) generated in each charging process (or discharging process), it is necessary to obtain the charging-electric-work (or discharging-electric-work) generated in each charging process (or discharging process), and then select an appropriate rated value as the normalizing divisor to calculate the weighted charging-electric-work (or the weighted discharging-electric-work). Further, in case the actual-work-capacity is adopted as the normalizing divisor in this process, the value of this normalizing divisor needs to be obtained in real-time, since the value of the actual-work-capacity will gradually degrade during the degradation process. As previous mentioned, when acquiring the value of one of the cumulative-consumption-indicators at a specific sampling time, the selected accumulation-range could be all of the historical spans or moments within the period from the production date of the battery to this specific sampling time.

In some embodiments, wherein constructing the comprehensive-lifetime-index comprises: using the lifetime feature fusion approach, with one or a plurality of traditional-lifetime-indicators and one or a plurality of the cumulative-consumption-indicators used as the input features, to construct and output the comprehensive-lifetime-index; specifically, using one or a plurality of the traditional-lifetime-indicators and one or a plurality of the cumulative-consumption-indicators as the input features, then the input features are organically fused using the lifetime feature fusion approach to form and output the comprehensive-lifetime-index.

In some embodiments, wherein the traditional-lifetime-indicators comprise: the accumulated amount of the charging iteration, the accumulated amount of the discharging iteration, the accumulated amount of the merge of charging and discharging iteration, or the accumulated amount of the service duration.

Traditional lifetime prognosis methods commonly adopt one of the traditional-lifetime-indicators to describe the degradation process, but few methods have attempted to using the lifetime feature fusion approach to construct comprehensive-lifetime-index. Therefore, when the comprehensive-lifetime-index is constructed through the lifetime feature fusion approach, it is also possible to select one or a plurality of the traditional-lifetime-indicators as (the optional types of) the input features, and finally all the selected input features can be used in the lifetime feature fusion approach to construct the comprehensive-lifetime-index, and this could still guarantee the creativity and progressiveness of the present Disclosure.

The accumulated amount of the charging iteration can be acquired by calculating the total number of the charging times within the selected accumulation-range. The accumulated amount of the discharging iteration can be acquired by calculating the total number of the discharging times within the selected accumulation-range. The accumulated amount of the merge of charging and discharging iteration can be acquired by calculating the total number of the charging times and discharging times within the selected accumulation-range. The above mentioned “charging iteration” or “discharging iteration” is not limited to the complete or incomplete charging or discharging process, which means, both complete or incomplete charging or discharging process are included in the number counting.

For rechargeable-battery, the accumulated amount of the service duration takes into account the accumulated hours of both resting duration, charging duration, and discharging duration. For rechargeable-battery, there are only three possible periods: charging period, discharging period, and resting period. Taking the accumulated amount of the service duration at a specific sampling time as an example, if all of the historical spans or moments within the period from the production date of the battery to this specific sampling time are defined as the accumulation-range, given in the fact that this selected accumulation-range is constantly, the value of the accumulated amount of the service duration is also the total hours length of the selected accumulation-range.

For the accumulated amount of the service duration, no matter whether the rechargeable-battery is in use or at rest, the accumulated amount of the service duration will continuously increase with the constant passage of actual calendar time.

In some embodiments, wherein the prognosis-features further comprise: a remaining-cumulable-amount of one of the traditional-lifetime-indicators before the rechargeable-battery fails, a value of one of the traditional-lifetime-indicators at the time when the rechargeable-battery fails, the future-dynamics between one of the traditional-lifetime-indicators and the health-status-index, or the future-dynamics between one of the traditional-lifetime-indicators and one of the key-performance-indicators.

In some embodiments, wherein the future-dynamics between one of the traditional-lifetime-indicators and the health-status-index comprise: within the future-lifetime-range starting from the prognosis-execution-time for future running of the rechargeable-battery, corresponding values of one of the traditional-lifetime-indicators when the health-status-index takes different values, or the corresponding values of the health-status-index when one of the traditional-lifetime-indicators takes different values.

In some embodiments, wherein the future-dynamics between one of the traditional-lifetime-indicators and one of the key-performance-indicators comprise: within the future-lifetime-range starting from the prognosis-execution-time for future running of the rechargeable-battery, the corresponding values of one of the key-performance-indicators when one of the traditional-lifetime-indicators takes different values, or the corresponding values of one of the traditional-lifetime-indicators when one of the key-performance-indicators takes different values.

To be compatible with traditional lifetime prognosis methods, such as those based on the number of charging-discharging cycles (also referred as accumulated amount of the merge of charging and discharging iteration in the present Disclosure), the steps of the present Disclosure could also include predicting the remaining-cumulable-amount of one of the traditional-lifetime-indicators before the battery fails, such as the remaining-cumulable-amount of the charging iteration (specifically the remaining-cumulable-amount of the charging iteration before the rechargeable-battery fails), the remaining-cumulable-amount of the service duration (specifically the remaining-cumulable-amount of the service duration before the rechargeable-battery fails), etc. In addition, it is also possible to predict the value of one of the traditional-lifetime-indicators at the time when the rechargeable-battery fails, such as the failure-cumulable-amount of the charging iteration (specifically the value of the accumulated amount of the charging iteration at the time when the rechargeable-battery fails), the failure-cumulable-amount of the service duration (specifically the value of the accumulated amount of the service duration at the time when the rechargeable-battery fails), etc. For example, it is possible for the present Disclosure to predict the remaining-lifetime of the rechargeable-battery according to Step 107, and then the predicted remaining-lifetime (of the comprehensive-lifetime-index) can be further converted into the remaining-cumulable-amount (of one or a plurality of the traditional-lifetime-indicators), according to the general relationship between the comprehensive-lifetime-index and one or a plurality of the traditional-lifetime-indicators (such as inferred from the priori-group of the degradation-data or the pre-established future utilization planning).

For example, if the accumulated amount of the discharging iteration is not adopted as the comprehensive-lifetime-index, while it is still necessary to predict and acquire the estimation result of the remaining-cumulable-amount of the discharging iteration; the technical solution would be to analysis the general relationship between the comprehensive-lifetime-index and the accumulated amount of the discharging iteration, and then predict the remaining-lifetime of the rechargeable-battery according to Step 107, which is also the remaining usable amount of the comprehensive-lifetime-index before the rechargeable-battery fails, and finally transform the remaining-lifetime (of the comprehensive-lifetime-index) into the remaining-cumulable-amount (of the discharging iteration), according to the acquired general relationship between the comprehensive-lifetime-index and the accumulated amount of the discharging iteration. In another example, if the accumulated amount of the service duration is not adopted as the comprehensive-lifetime-index, while it is still necessary to predict and acquire the estimation result of the remaining-cumulable-amount of the service duration; the technical solution would be to analysis the general relationship between the comprehensive-lifetime-index and the accumulated amount of the service duration, and then predict the remaining-lifetime of the rechargeable-battery according to Step 107, which is also the remaining usable amount of the comprehensive-lifetime-index before the rechargeable-battery fails, and finally transform the remaining-lifetime (of the comprehensive-lifetime-index) into the remaining-cumulable-amount (of the service duration), according to the acquired general relationship between the comprehensive-lifetime-index and the accumulated amount of the service duration. The description here is only illustrative, and the present Disclosure does not make any limitations on it. If it is necessary to obtain the remaining-cumulable-amount of one or a plurality of the traditional-lifetime-indicators, a similar operation can also be used by referring to the above introduction.

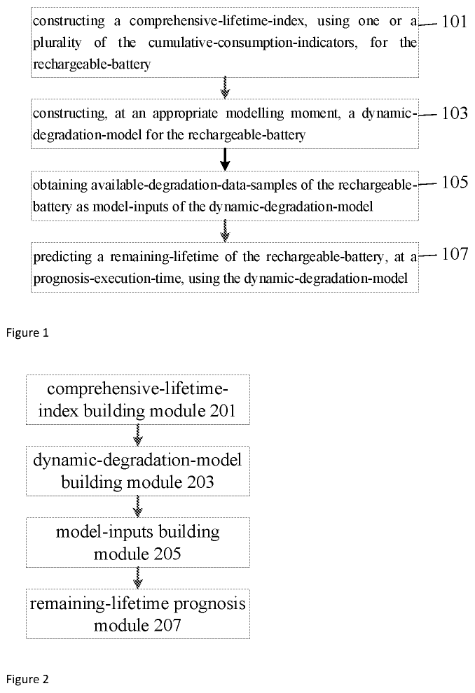

FIG. 2 is a block diagram illustrating a lifetime prognosis device for rechargeable-battery based on the cumulative-consumption-indicators according to an exemplary embodiment. In some embodiments, the lifetime prognosis device comprises: a comprehensive-lifetime-index building module 201, a dynamic-degradation-model building module 203, a model-inputs building module 205, and a remaining-lifetime prognosis module 207.

The comprehensive-lifetime-index building module 201, which is configured to construct the comprehensive-lifetime-index, using one or a plurality of the cumulative-consumption-indicators, for the rechargeable-battery; the dynamic-degradation-model building module 203, which is configured to construct, at the appropriate modelling moment, the dynamic-degradation-model for the rechargeable-battery; the model-inputs building module 205, which is configured to obtain the available-degradation-data-samples of the rechargeable-battery as the model-inputs of the dynamic-degradation-model; the remaining-lifetime prognosis module 207, which is configured to predict the remaining-lifetime of the rechargeable-battery, at the prognosis-execution-time, using the dynamic-degradation-model.

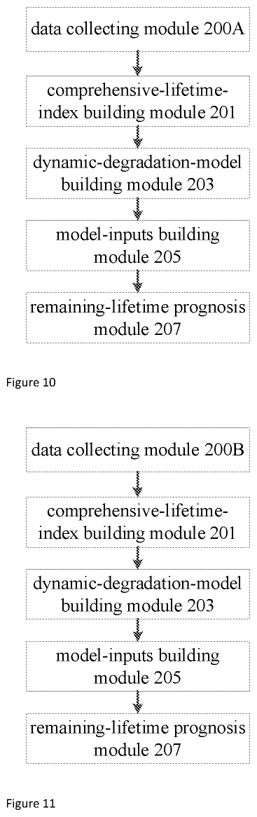

In some embodiments, the lifetime prognosis device further comprises: a data collecting module 200A, which is configured to collect, at the appropriate collecting moment, the available-degradation-data-samples of the rechargeable-battery. FIG. 10 is a block diagram illustrating a lifetime prognosis device for rechargeable-battery based on the cumulative-consumption-indicators according to another exemplary embodiment.

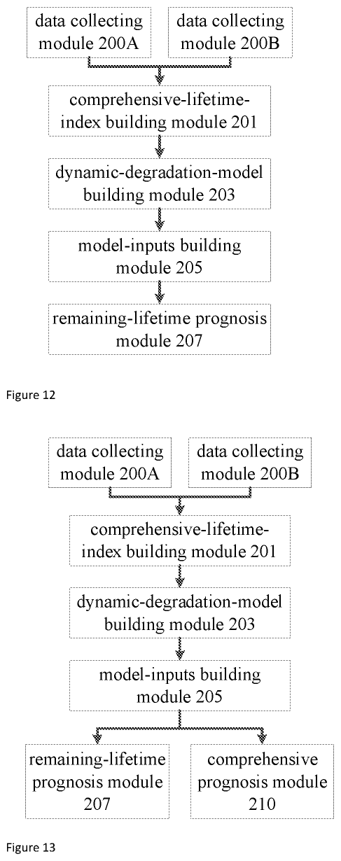

In some embodiments, the lifetime prognosis device further comprises: a data collecting module 2006, which is configured to collect, at the appropriate collecting moment, the available-degradation-data-samples of other-similar-batteries that are similar or identical to the rechargeable-battery. FIG. 11 is a block diagram illustrating a lifetime prognosis device for rechargeable-battery based on the cumulative-consumption-indicators according to another exemplary embodiment. FIG. 12 is a block diagram illustrating a lifetime prognosis device for rechargeable-battery based on the cumulative-consumption-indicators according to another exemplary embodiment.

In some embodiments, the lifetime prognosis device further comprises: a comprehensive prognosis module 210, which is configured to predict one or a plurality of the prognosis-features of the rechargeable-battery, at the prognosis-execution-time, using the dynamic-degradation-model. FIG. 13 is a block diagram illustrating a lifetime prognosis device for rechargeable-battery based on the cumulative-consumption-indicators according to another exemplary embodiment.

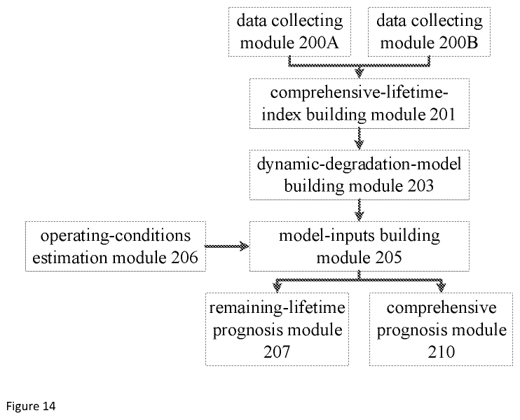

In some embodiments, the lifetime prognosis device further comprises: an operating-conditions estimation module 206, which is configured to estimate the future-operating-conditions of the rechargeable-battery. FIG. 14 is a block diagram illustrating a lifetime prognosis device for rechargeable-battery based on the cumulative-consumption-indicators according to another exemplary embodiment.

The embodiments of the present Disclosure introduce the lifetime prognosis device for rechargeable-battery based on the cumulative-consumption-indicators, which can be realized according to the lifetime prognosis method described by embodiments of the present Disclosure, the detailed implementation process can refer to related descriptions based on embodiments of the lifetime prognosis method, which will not be repeated here.

Seen from the above descriptions, the present Disclosure designs and adopts the comprehensive-lifetime-index and health-status-index to describe the degradation process of the rechargeable-battery, and may also consider different operating-conditions and their influence on degradation trend, and further could make feature fusion with one or a plurality of the comprehensive-lifetime-indicators or one or a plurality of the key-performance-indicators according to actual needs. As a result, the disclosure significantly improves the accuracy of the remaining-lifetime prognosis of rechargeable-batteries, especially in daily practical applications.

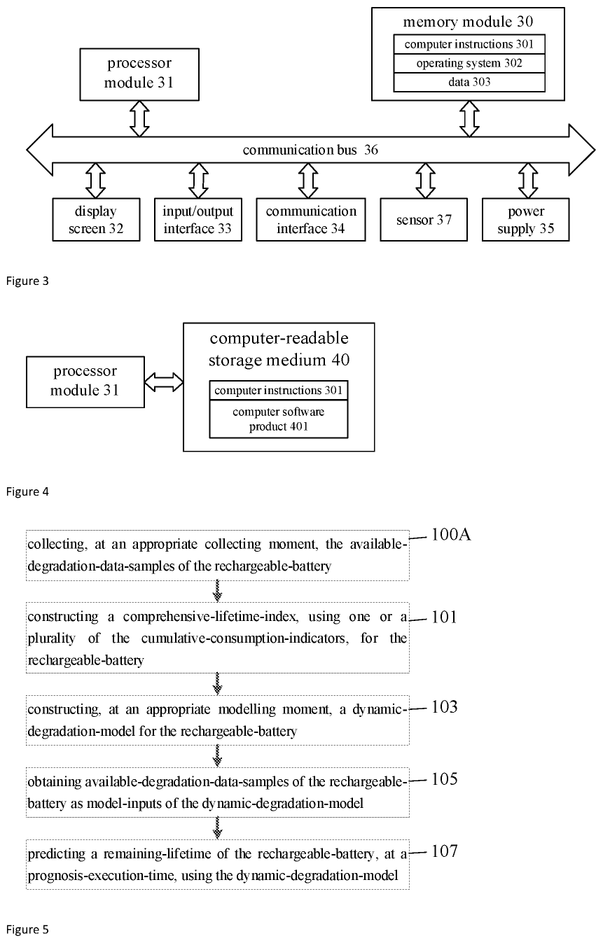

The above-mentioned lifetime prognosis device for rechargeable-battery based on the cumulative-consumption-indicators is described from the perspective of functional modules. Furthermore, the present Disclosure also provides an electronic equipment, which is described from the perspective of hardware. FIG. 3 is a block diagram illustrating an electronic equipment according to an exemplary embodiment. In some embodiments, a lifetime prognosis electronic equipment is provided, comprised of: a memory module 30, which is configured to store computer instructions 301; a processor module 31, coupled to the memory module 30, which is configured to execute the computer instructions 301 stored in the memory module to realize the lifetime prognosis method for rechargeable-battery based on the cumulative-consumption-indicators as described in any of above embodiments.

In some embodiments, the processor module 31 may include one or more processing cores, such as a 4-core processor, an 8-core processor, etc. The processor module 31 can adopt at least one hardware form from DSP (Digital Signal Processing), FPGA (Field-Programmable Gate Array), and PLA (Programmable Logic Array). The processor module 31 can also comprise the main processor and co-processor, and the main processor is used for processing the data in the wake-up state, also known as CPU (Central Processing Unit, central processing unit); the co-processor is a low-power processor for processing data in the standby state. In some embodiments, the processor module 31 can also be integrated with the GPU (Graphics Processing Unit), which is used to render and draw the content to be displayed on the display screen. In some embodiments, the processor module 31 may also include an AI (Artificial Intelligence) processor for processing computing operations related to machine learning.

In some embodiments, the memory module 30 may include high-speed RAM (Random Access Memory), or NVM (Non-Volatile Memory). For example, at least one disk storage. The memory module 30 may also be a memory array. The memory module 30 may also be partitioned, and the blocks may be combined into virtual volumes according to certain rules. In some embodiment, the memory module 30 at least can be used to store the computer instructions 301. After the computer instructions 301 is loaded and executed by the processor module 31, the steps of the lifetime prognosis method for rechargeable-battery based on the cumulative-consumption-indicators disclosed in any of the aforementioned embodiments can be realized. In addition, the resources stored in the memory module 30 can also include operating system 302, data 303, etc. The storage mode can be temporary storage or permanent storage. Among them, the operating system 302 can include Windows, Unix, Linux, etc. The data 303 may include, but is not limited to, data corresponding to test results.

In some embodiments, the lifetime prognosis device for rechargeable-battery based on the cumulative-consumption-indicators may also include a display screen 32, an input/output interface 33, a communication interface 34, a power supply 35, and a communication bus 36.

It can be understood by those ordinary technicians in the relevant field that the structure shown in FIG. 3 does not constitute a limitation of the lifetime prognosis method for rechargeable-battery based on the cumulative-consumption-indicators, and it may include more or fewer components than shown in the figure, such as the sensor 37.

The functions of each functional module of the electronic equipment described by embodiments of the present Disclosure can be specifically realized according to the method embodiments described in above.

The embodiments of the present Disclosure also provide a computer-readable storage medium 40, wherein the computer-readable storage medium 40 stores the computer instructions 301, and when the computer instructions 301 are executed by the processor module 31, the lifetime prognosis method for the rechargeable-battery based on the cumulative-consumption-indicators as described in any of above embodiments can be realized. FIG. 4 is a block diagram illustrating a computer-readable storage medium according to an exemplary embodiment.

It should be understood that if the lifetime prognosis method for rechargeable-battery based on the cumulative-consumption-indicators that mentioned in above embodiments is implemented in the form of a software functional unit and sold or used as an independent product, it can be stored in a computer-readable storage medium 40. Based on this understanding, the technical solution of the present Disclosure, in essence, or the part that contributes to the prior art, or the whole or part of the technical solution, can be embodied in the form of a computer software product 401. The computer software product 401 is stored in a computer-readable storage medium 40 and executes all or part of the steps of the methods of each embodiment of the present Disclosure. The aforementioned computer-readable storage medium 40 include: USB flash disk, removable hard disk, read only memory (ROM), random access memory (RAM), electrically erasable programmable ROM, registers, hard disk, removable disk, CD-ROM, magnetic disks or optical disks and other mediums that can store program codes.

The functions of each functional module of the computer-readable storage medium 40 described in the embodiments of the present Disclosure can be realized according to the lifetime prognosis method in the above-mentioned method embodiments, and its specific implementation process can refer to the relevant description of the above-mentioned method embodiments, and will not be repeated here repeat.

Seen from the above descriptions, the present Disclosure designs and adopts the comprehensive-lifetime-index and health-status-index to describe the degradation process of the rechargeable-battery, and may also consider different operating-conditions and their influence on degradation trend, and further could make feature fusion with one or a plurality of the comprehensive-lifetime-indicators or one or a plurality of the key-performance-indicators according to actual needs. As a result, the disclosure significantly improves the accuracy of the remaining-lifetime prognosis of rechargeable-batteries, especially in daily practical applications.

In the Description part of present Disclosure, each embodiment is described in a progressive manner, and each embodiment focuses on the differences with other embodiments. The same or similar parts of each embodiment can be referred to each other. For the lifetime prognosis device disclosed in above embodiments, since it corresponds to the lifetime prognosis method disclosed in above embodiments, the description is relatively simple, please refer to the description of the method parts for details.

Ordinary technicians in the relevant field can further realize that the units and algorithm steps of each example described in any of the embodiments disclosed herein can be implemented in electronic hardware, computer software, or a merge of the two. In order to clearly explain the interchangeability of hardware and software, the compositions and steps of each embodiment have been generally described in the above description according to their functions. Whether these functions are implemented in hardware or software depends on the specific application and design constraints of the technical solution. Ordinary technicians in the relevant field can use different implementation approaches to realize the described functions in different application scenarios, but such implementation should not be considered beyond the scope of the present Disclosure.

The method, device, electronic equipment and computer-readable storage medium for lifetime prognosis of rechargeable-battery based on the cumulative-consumption-indicators provided by the present Disclosure have been described above in detail. In the present Disclosure, specific embodiments are used to illustrate the principle and implementation of the present Disclosure, and the descriptions of the above embodiments are only used to help understand the method and core idea of the present Disclosure. It should be pointed out that those ordinary technicians in the relevant field can make several improvements and modifications to the present Disclosure without departing from the principle of the present Disclosure, and these improvements and modifications also fall within the protection scope of the claims of the present Disclosure.

It should be noted that there is no strict order of execution among the steps of the present Disclosure. As long as they conform to the logical order, these steps can be executed at the same time or in a certain preset order. FIGS. 1 to 3 are just schematic representations, and do not mean that only such an execution sequence can be used.

The traditional lifetime prognosis methods for rechargeable-batteries commonly adopt the accumulated amount of the merge of charging and discharging iteration as the lifetime index, while such traditional-lifetime-indicators are incapable to deal with random charging and discharging, irregular resting, calendar ageing or some other common phenomena in common daily life, therefore those traditional prognosis methods have only limited prognosis performance in practical application. The present Disclosure designs and adopts the comprehensive-lifetime-index and health-status-index to describe the degradation process of the rechargeable-battery, and may also consider different operating-conditions and their influence on degradation trend, and further could make feature fusion with one or a plurality of the comprehensive-lifetime-indicators or one or a plurality of the key-performance-indicators according to actual needs. As a result, the disclosure significantly improves the accuracy of the remaining-lifetime prognosis of rechargeable-batteries, especially in daily practical applications.

1. A lifetime prognosis method for a rechargeable-battery based on cumulative-consumption-indicators, characterized in that the method comprising:
constructing a comprehensive-lifetime-index, using one or a plurality of the cumulative-consumption-indicators, for the rechargeable-battery;
constructing, at an appropriate modelling moment, a dynamic-degradation-model for the rechargeable-battery;
obtaining available-degradation-data-samples of the rechargeable-battery as model-inputs of the dynamic-degradation-model;
predicting a remaining-lifetime of the rechargeable-battery, at a prognosis-execution-time, using the dynamic-degradation-model.

2. The method of claim 1,
wherein the dynamic-degradation-model is used to describe a dynamic degradation pattern of the rechargeable-battery that characterized by decay in the value of the comprehensive-lifetime-index, during a degradation process of the rechargeable-battery, as the value of the comprehensive lifetime index constantly increases;
wherein constructing the comprehensive-lifetime-index comprises: selecting one of the cumulative-consumption-indicators as the comprehensive-lifetime-index;
wherein the cumulative-consumption-indicators comprise: an accumulated amount obtained by accumulating values of a usage-metric of the rechargeable-battery; but the usage-metric do not comprise: a charging iteration, a discharging iteration, a merge of charging and discharging iteration, or a service duration; and the cumulative-consumption-indicators do not comprise: an accumulated amount of the charging iteration, an accumulated amount of the discharging iteration, an accumulated amount of the merge of charging and discharging iteration, or an accumulated amount of the service duration;
wherein the available-degradation-data-samples comprise: degradation-data sampled in real-time, the degradation-data sampled at all of historical spans or moments, or the degradation-data sampled at partial of the historical spans or moments;
wherein the degradation-data comprises: performance monitoring data that are closely related to the degradation process of the rechargeable-battery.

3. The method of claim 2,
wherein the usage-metric comprise: a charging-electricity-quantity, a discharging-electricity-quantity, a merge of absolute charging and discharging electricity-quantity; wherein the cumulative-consumption-indicators further comprise: an accumulated amount of the charging-electricity-quantity, an accumulated amount of the discharging-electricity-quantity, or an accumulated amount of the merge of absolute charging and discharging electricity-quantity;
wherein the usage-metric further comprise: a charging-electric-work, a discharging-electric-work, a merge of absolute charging and discharging electric-work; wherein the cumulative-consumption-indicators further comprise: an accumulated amount of the charging-electric-work, an accumulated amount of the discharging-electric-work, or an accumulated amount of the merge of absolute charging and discharging electric-work;
wherein the usage-metric further comprise: a charging duration, a discharging duration, a merge of charging and discharging duration; wherein the cumulative-consumption-indicators further comprise: an accumulated amount of the charging duration, an accumulated amount of the discharging duration, or an accumulated amount of the merge of charging and discharging duration;
wherein the usage-metric further comprise: a resting iteration, a resting duration; wherein the cumulative-consumption-indicators further comprise: an accumulated amount of the resting iteration, or an accumulated amount of the resting duration;
wherein the process to acquire a value of one of the cumulative-consumption-indicators at a sampling time, comprise: selecting all of the historical spans or moments during a period from a production date of the rechargeable-battery to the sampling time as an accumulation-range, then selecting the usage-metric of the rechargeable-battery according to actual needs as object for accumulation, and then accumulating the values of the usage-metric within the accumulation-range to get an accumulated result, finally using the accumulated result as the value of one of the cumulative-consumption-indicators at the sampling time.

4. The method of claim 3,
wherein an alternative approach for selecting the accumulation-range, during the process to acquire the value of one of the cumulative-consumption-indicators at the sampling time, further comprises: the first viable option that selecting all of the historical spans or moments during a period from a put-into-use date of the rechargeable-battery to the sampling time as the accumulation-range, the second viable option that appointing a certain fixed time as an initial accumulation point then selecting all of the historical spans or moments during a period from the initial accumulation point to the sampling time as the accumulation-range, or the third viable option that selecting partial of the historical spans or moments during a period from the production date of the rechargeable-battery to the sampling time as the accumulation-range;
wherein constructing the health-status-index comprises: selecting one of the key-performance-indicators as the health-status-index;
wherein one of the key-performance-indicators is defined as one of working performances of the rechargeable-battery, and a value of the one of the working performances will gradually decay with long-term usage of the rechargeable-battery; specifically, a value of the one of the key-performance-indicators at the sampling time is also the value of the one of the working performances at the sampling time;
wherein a failure threshold is a value within feasible value range of the health-status-index of the rechargeable-battery, and the rechargeable-battery fails when a value of the health-status-index decays to the failure threshold;
wherein the key-performance-indicators comprise: an actual-quantity-capacity, or an attenuation of the actual-quantity-capacity;
wherein the key-performance-indicators further comprise: an actual-internal-resistance, or an attenuation of the actual-internal-resistance;
wherein the key-performance-indicators further comprise: an actual-work-capacity, or an attenuation of the actual-work-capacity.

5. The method of claim 4,
wherein the rechargeable-battery in physical structure comprise: a battery individual composed by a single battery cell, a battery pack composed by multiple battery cells connected in series or parallel, or a battery cluster composed by organic integration of multiple battery cells or battery packs;
wherein the rechargeable-battery in chemical structure comprise: lithium battery, lithium-ion battery, lithium-sulfur battery, sodium battery, sodium-ion battery, aluminum battery, aluminum-ion battery, graphene battery, sulfur battery, nickel-metal hydride battery, lead storage battery, all-solid-state battery, solid-liquid hybrid battery, metal battery, metal-ion battery, air battery, cylindrical battery, polymer battery, power battery, halide battery, silicon-based battery, supercapacitor, or other recyclable power storage device;
wherein the degradation-data further comprises: values of one or a plurality of the cumulative-consumption-indicators, or values of one or a plurality of the key-performance-indicators;
wherein the remaining-lifetime equals to a difference between a failure-lifetime and a current-lifetime, which represents a remaining usable amount of the comprehensive-lifetime-index before the rechargeable-battery fails; specifically, a value of the remaining-lifetime at the prognosis-execution-time is also a difference between a value of the failure-lifetime and a value of the current-lifetime at the prognosis-execution-time;
wherein the failure-lifetime equals to a value of the comprehensive-lifetime-index when the rechargeable-battery fails; specifically, the value of the failure-lifetime is also the value of the comprehensive-lifetime-index at the time when the value of the health-status-index decays to the failure threshold;
wherein the current-lifetime, at each the prognosis-execution-time, is also the value of the comprehensive-lifetime-index; specifically, the value of the current-lifetime at the prognosis-execution-time is also the value of the comprehensive-lifetime-index at the prognosis-execution-time.

6. The method of claim 5,
wherein an approach for setting the failure threshold comprise: preset the failure threshold in advance, or setting the failure threshold according to an inherent law inferred from a priori-group of the degradation-data;
wherein constructing, at the appropriate modelling moment, the dynamic-degradation-model for the rechargeable-battery, comprise: selecting an empirical mathematical model according to actual needs, and then setting model parameters of the empirical mathematical model, and finally combining the empirical mathematical model with the model parameters as the dynamic-degradation-model; values of the model parameters can be preset in advance or be obtained by training the empirical mathematical model based on the priori-group of the degradation-data;
wherein constructing, at the appropriate modelling moment, the dynamic-degradation-model for the rechargeable-battery, further comprise: selecting a neural network prognosis model according to actual needs, and then training parameters and hyperparameters of the neural network prognosis model based on the priori-group of the degradation-data, finally combining the neural network prognosis model with its parameters and hyperparameters as the dynamic-degradation-model;
wherein the priori-group of the degradation-data comprise: the available-degradation-data-samples of the rechargeable-battery, or the available-degradation-data-samples of other-similar-batteries that are similar or identical to the rechargeable-battery;
wherein the lifetime prognosis method further comprising: collecting, at an appropriate collecting moment, the available-degradation-data-samples of the rechargeable-battery;
wherein the lifetime prognosis method further comprising: collecting, at the appropriate collecting moment, the available-degradation-data-samples of other-similar-batteries that are similar or identical to the rechargeable-battery.

7. The method of claim 6,
wherein constructing the health-status-index comprises: using a performance feature fusion approach, with a plurality of the key-performance-indicators used as input features, to construct and output the health-status-index; specifically, using two, three, four, or a plurality of the key-performance-indicators as the input features, then the input features are organically fused using the performance feature fusion approach to form and output the health-status-index;
wherein constructing the comprehensive-lifetime-index comprises: using a lifetime feature fusion approach, with a plurality of the cumulative-consumption-indicators used as the input features, to construct and output the comprehensive-lifetime-index; specifically, using two, three, four, or a plurality of the cumulative-consumption-indicators as the input features, then the input features are organically fused using the lifetime feature fusion approach to form and output the comprehensive-lifetime-index;
wherein constructing the comprehensive-lifetime-index or the health-status-index using the lifetime feature fusion approach or performance feature fusion approach comprises: setting weight-coefficients for each of the input features, then weighting each of the input features according to the weight-coefficients, and finally summing up the input features to build and output the comprehensive-lifetime-index or the health-status-index; values of the weight-coefficients can be preset in advance or be obtained by training based on the priori-group of the degradation-data, but the values of the weight-coefficients corresponding to each of the input features is all non-zero, and the values of the weight-coefficients are not completely equal to each other;
wherein constructing the comprehensive-lifetime-index or the health-status-index using the lifetime feature fusion approach or performance feature fusion approach further comprises:
selecting a neural network feature model to process the input features, then taking the output of the neural network feature model as the comprehensive-lifetime-index or the health-status-index; the neural network feature model with its parameters and hyperparameters can be preset in advance or be obtained by training based on the priori-group of the degradation-data.

8. The method of claim 7,
wherein the actual-quantity-capacity comprises a maximum electricity quantity storage capacity of the rechargeable-battery in a fully charged state, which represents a charging electricity quantity limitation or a discharging electricity quantity limitation of the rechargeable-battery, and a value of the actual-quantity-capacity will gradually decay with the long-term usage of the rechargeable-battery;
wherein the value of the actual-quantity-capacity comprises: an amount of the charging-electricity-quantity that can be charged into the rechargeable-battery during a complete charging process for charging the rechargeable-battery from a fully discharged state to the fully charged state, or an amount of the discharging-electricity-quantity that can be discharged out of the rechargeable-battery during a complete discharging process for discharging the rechargeable-battery from the fully charged state to the fully discharged state;
wherein the actual-work-capacity comprises the maximum electric work storage capacity of the rechargeable-battery in the fully charged state, which represents a charging electric work limitation or a discharging electric work limitation of the rechargeable-battery, and a value of the actual-work-capacity will gradually decay with the long-term usage of the rechargeable-battery;
wherein the value of the actual-work-capacity comprises: an amount of the charging-electric-work that can be charged into the rechargeable-battery during the complete charging process for charging the rechargeable-battery from the fully discharged state to the fully charged state; or an amount of the discharging-electric-work that can be discharged out of the rechargeable-battery during the complete discharging process for discharging the rechargeable-battery from the fully charged state to the fully discharged state;
In some embodiments, wherein collecting, at the appropriate collecting moment, the available-degradation-data-samples, specifically of one of the individual batteries from the rechargeable-battery or the other-similar-batteries, comprise: the first viable option that collecting the degradation-data in real-time of the one of the individual batteries at the appropriate collecting moment, the second viable option that collecting the degradation-data in history of the one of the individual batteries at all of the historical spans or moments during a period from the production date of the one of the individual batteries to the appropriate collecting moment, or the third viable option that collecting the degradation-data in history of the one of the individual batteries at partial of the historical spans or moments during the period from the production date of the one of the individual batteries to the appropriate collecting moment.

9. The method of claim 8,
wherein a function of the dynamic-degradation-model further comprises: be able to predict one or a plurality of prognosis-features of the rechargeable-battery;
wherein the lifetime prognosis method further comprising: predicting one or a plurality of the prognosis-features of the rechargeable-battery using the dynamic-degradation-model;
wherein the prognosis-features comprise: an optimal planned maintenance time, an optimal planned replacement time, the failure-lifetime, the current-lifetime, a relative remaining-lifetime, or a relative current-lifetime;
wherein the relative remaining-lifetime comprises a ratio of the remaining-lifetime to the failure-lifetime; wherein the relative current-lifetime comprises a ratio of the current-lifetime to the failure-lifetime;
wherein the prognosis-features further comprise: a remaining-cumulable-amount of one of the cumulative-consumption-indicators before the rechargeable-battery fails, the value of one of the cumulative-consumption-indicators when the rechargeable-battery fails, future-dynamics between the health-status-index and the comprehensive-lifetime-index, future-dynamics between one of the key-performance-indicators and the comprehensive-lifetime-index, future-dynamics between one of the cumulative-consumption-indicators and the health-status-index, or future-dynamics between one of the cumulative-consumption-indicators and one of the key-performance-indicators;
wherein the future-dynamics between the health-status-index and the comprehensive-lifetime-index comprise: within a future-lifetime-range starting from the prognosis-execution-time for future running of the rechargeable-battery, corresponding values of the health-status-index when the comprehensive-lifetime-index takes different values, or corresponding values of the comprehensive-lifetime-index when the health-status-index takes different values;
wherein the future-dynamics between one of the key-performance-indicators and the comprehensive-lifetime-index comprise: within the future-lifetime-range starting from the prognosis-execution-time for future running of the rechargeable-battery, corresponding values of one of the key-performance-indicators when the comprehensive-lifetime-index takes different values, or the corresponding values of the comprehensive-lifetime-index when one of the key-performance-indicators takes different values;
wherein the future-dynamics between one of the cumulative-consumption-indicators and the health-status-index comprise: within the future-lifetime-range starting from the prognosis-execution-time for future running of the rechargeable-battery, corresponding values of one of the cumulative-consumption-indicators when the health-status-index takes different values, or the corresponding values of the health-status-index when one of the cumulative-consumption-indicators takes different values;
wherein the future-dynamics between one of the cumulative-consumption-indicators and one of the key-performance-indicators comprise: within the future-lifetime-range starting from the prognosis-execution-time for future running of the rechargeable-battery, the corresponding values of one of the key-performance-indicators when one of the cumulative-consumption-indicators takes different values, or the corresponding values of one of the cumulative-consumption-indicators when one of the key-performance-indicators takes different values.

10. The method of claim 9,
wherein the degradation-data further comprises: values of one or a plurality of operating-conditions; generally, changes in value of one or a plurality of the operating-conditions may affect the working performances of the rechargeable-battery in use, and then may affect the dynamic degradation pattern of the rechargeable-battery;
wherein the operating-conditions comprise: changes in value of a battery terminal voltage, changes in value of a battery terminal current, changes in value of a battery terminal power, changes in value of a battery body temperature, or changes in value of an external environment temperature, within each of charging processes or each of discharging processes of the rechargeable-battery;
wherein the operating-conditions further comprise: mean average of the battery terminal voltage, mean average of the battery terminal current, mean average of the battery terminal power, mean average of the battery body temperature, or mean average of the external environment temperature, within each of the charging processes or each of the discharging processes of the rechargeable-battery;
wherein the operating-conditions further comprise: charging cut-off current of the rechargeable-battery in each of the charging processes, or discharging cut-off voltage of the rechargeable-battery in each of the discharging processes; the charging cut-off current refers to a preset current limit at which the rechargeable-battery should not continue to charge when the battery terminal current drops to this preset current limit during each of the charging processes; the discharging cut-off voltage refers to a preset voltage limit at which the rechargeable-battery should not continue to discharge when the battery terminal voltage drops to this preset voltage limit during each of the discharging processes;
wherein the key-performance-indicators further comprise: one or a plurality of the cumulative-consumption-indicators;
wherein the function of the dynamic-degradation-model further comprises: be able to consider influence of the operating-conditions on the dynamic degradation pattern of the rechargeable-battery;
wherein predicting the remaining-lifetime of the rechargeable-battery further comprises:
considering influence of future-operating-conditions on the dynamic degradation pattern of the rechargeable-battery, then adopting estimation results of the future-operating-conditions of the rechargeable-battery as additional model-inputs of the dynamic-degradation-model, finally using the dynamic-degradation-model to predict the remaining-lifetime of the rechargeable-battery.

11. The method of claim 10, wherein,
wherein the future-operating-conditions comprise: the values of one or a plurality of the operating-conditions within the future-lifetime-range starting from the prognosis-execution-time for future running of the rechargeable-battery;
wherein the lifetime prognosis method further comprising: estimating the future-operating-conditions of the rechargeable-battery;
wherein a condition estimation approach for estimating the future-operating-conditions of the rechargeable-battery comprises: the first viable option that estimating the future-operating-conditions of the rechargeable-battery according to a pre-established future utilization planning, or the second viable option that estimating the future-operating-conditions of the rechargeable-battery according to inherent changing patterns of the operating-conditions that can be inferred from the priori-group of the degradation-data;
wherein estimating the future-operating-conditions of the rechargeable-battery further comprises: the first viable option that assuming the values of one or a plurality of the operating-conditions will change with time during the future-lifetime-range and then using the condition estimation approach to estimate changing dynamics of one or a plurality of the operating-conditions over the future-lifetime-range, or the second viable option that assuming the values of one or a plurality of the operating-conditions will remain stable during the future-lifetime-range and then using the condition estimation approach to estimate mean values of one or a plurality of the operating-conditions over the future-lifetime-range;
wherein predicting one or a plurality of the prognosis-features of the rechargeable-battery further comprises: considering influence of future-operating-conditions on the dynamic degradation pattern of the rechargeable-battery, then adopting estimation results of the future-operating-conditions of the rechargeable-battery as the additional model-inputs of the dynamic-degradation-model, finally using the dynamic-degradation-model to predict one or a plurality of the prognosis-features of the rechargeable-battery;
wherein accumulating the values of the usage-metric within the accumulation-range to get an accumulated result, during the process to acquire the value of one of the cumulative-consumption-indicators at the sampling time, further comprise: accumulating, considering impacts of one or a plurality of the operating-conditions, the values of the usage-metric within the accumulation-range to get an accumulated result; wherein accumulating, considering the impacts of one or a plurality of the operating-conditions, the values of the usage-metric within the accumulation-range to get an accumulated result, comprise:
obtaining the values of one or a plurality of the operating-conditions at each time within the accumulation-range, then generating values of weighted-coefficient for the values of one or a plurality of the operating-conditions at each time within the accumulation-range according to specific models or rules, and then obtaining values of weighted usage-metric at each time within the accumulation-range by multiplying the values of the usage-metric and the values of the weighted-coefficient at each time within the accumulation-range, and then accumulating the values of the weighted usage-metric over the accumulation-range to get the accumulated result, finally using the accumulated result as the value of one of the cumulative-consumption-indicators at the sampling time; the specific models or rules can be obtained by training based on the priori-group of the degradation-data or can be preset in advance;
wherein the usage-metric, under the precondition of considering the impacts of one or a plurality of the operating-conditions when accumulating the values of the usage-metric within the accumulation-range to get an accumulated result, further comprise: the charging iteration, the discharging iteration, the merge of charging and discharging iteration, or the service duration;
wherein the cumulative-consumption-indicators, under the precondition of considering the impacts of one or a plurality of the operating-conditions when accumulating the values of the usage-metric within the accumulation-range to get an accumulated result, further comprise: the accumulated amount of the charging iteration, the accumulated amount of the discharging iteration, the accumulated amount of the merge of charging and discharging iteration, or the accumulated amount of the service duration.

12. The method of claim 11,
wherein the usage-metric further comprise: an actual workload generated by a battery powered equipment, an actual work generated by the battery powered equipment, an actual mileage generated by a battery powered vehicle; wherein the cumulative-consumption-indicators further comprise: an accumulated amount of the actual workload generated by the battery powered equipment, an accumulated amount of the actual work generated by the battery powered equipment, or an accumulated amount of the actual mileage generated by the battery powered vehicle;
wherein the key-performance-indicators further comprise: an actual workload generated by the battery powered equipment by discharging the rechargeable-battery from the fully charged state to the fully discharged state, an actual work generated by the battery powered equipment by discharging the rechargeable-battery from the fully charged state to the fully discharged state, or an actual mileage generated by the battery powered vehicle by discharging the rechargeable-battery from the fully charged state to the fully discharged state;
wherein the operating-conditions further comprise: changes in value of an operating-power of the battery powered equipment within each of the charging processes or each of the discharging processes, or mean average of the operating-power of the battery powered equipment within each of the charging processes or each of the discharging processes;
wherein the operating-conditions further comprise: changes in value of a production-efficiency of the battery powered equipment within each of the charging processes or each of the discharging processes, or mean average of the production-efficiency of the battery powered equipment within each of the charging processes or each of the discharging processes;
wherein the operating-conditions further comprise: changes in value of a driving speed of the battery powered vehicle within each of driving processes, or mean average of the driving speed of the battery powered vehicle within each of the driving processes;
wherein the usage-metric further comprise: one of the operating-conditions; wherein the cumulative-consumption-indicators further comprise: an accumulated amount of one of the operating-conditions; specifically, the process to acquire the accumulated amount of one of the operating-conditions comprise: taking one of the operating-conditions as object for accumulation, then accumulating the values of one of the operating-conditions within the accumulation-range to get the accumulated result, finally using the accumulated result as the value of one of the cumulative-consumption-indicators at the sampling time;
wherein the usage-metric further comprise: a weighted charging-electric-work, a weighted discharging-electric-work, a weighted merge of absolute charging and discharging electric-work; wherein the cumulative-consumption-indicators further comprise: an accumulated amount of the weighted charging-electric-work, an accumulated amount of the weighted discharging-electric-work, or an accumulated amount of the weighted merge of absolute charging and discharging electric-work;
wherein the weighted charging-electric-work comprise: a ratio of the charging-electric-work to a rated-work-capacity, a ratio of the charging-electric-work to an initial-work-capacity, or a ratio of the charging-electric-work to the actual-work-capacity; wherein the weighted discharging-electric-work comprise: a ratio of the discharging-electric-work to the rated-work-capacity, a ratio of the discharging-electric-work to the initial-work-capacity, or a ratio of the discharging-electric-work to the actual-work-capacity.

13. The method of claim 12, wherein,
wherein constructing the comprehensive-lifetime-index comprises: using the lifetime feature fusion approach, with one or a plurality of traditional-lifetime-indicators and one or a plurality of the cumulative-consumption-indicators used as the input features, to construct and output the comprehensive-lifetime-index; specifically, using one or a plurality of the traditional-lifetime-indicators and one or a plurality of the cumulative-consumption-indicators as the input features, then the input features are organically fused using the lifetime feature fusion approach to form and output the comprehensive-lifetime-index;
wherein the traditional-lifetime-indicators comprise: the accumulated amount of the charging iteration, the accumulated amount of the discharging iteration, the accumulated amount of the merge of charging and discharging iteration, or the accumulated amount of the service duration;
wherein the prognosis-features further comprise: a remaining-cumulable-amount of one of the traditional-lifetime-indicators before the rechargeable-battery fails, a value of one of the traditional-lifetime-indicators at the time when the rechargeable-battery fails, the future-dynamics between one of the traditional-lifetime-indicators and the health-status-index, or the future-dynamics between one of the traditional-lifetime-indicators and one of the key-performance-indicators;
wherein the future-dynamics between one of the traditional-lifetime-indicators and the health-status-index comprise: within the future-lifetime-range starting from the prognosis-execution-time for future running of the rechargeable-battery, corresponding values of one of the traditional-lifetime-indicators when the health-status-index takes different values, or the corresponding values of the health-status-index when one of the traditional-lifetime-indicators takes different values;
wherein the future-dynamics between one of the traditional-lifetime-indicators and one of the key-performance-indicators comprise: within the future-lifetime-range starting from the prognosis-execution-time for future running of the rechargeable-battery, the corresponding values of one of the key-performance-indicators when one of the traditional-lifetime-indicators takes different values, or the corresponding values of one of the traditional-lifetime-indicators when one of the key-performance-indicators takes different values;
wherein the usage-metric further comprise: a weighted charging-electricity-quantity, a weighted discharging-electricity-quantity, a weighted merge of absolute charging and discharging electricity-quantity; wherein the cumulative-consumption-indicators further comprise: an accumulated amount of the weighted charging-electricity-quantity, an accumulated amount of the weighted discharging-electricity-quantity, or an accumulated amount of the weighted merge of absolute charging and discharging electricity-quantity;
wherein the weighted charging-electricity-quantity comprise: a ratio of the charging-electricity-quantity to a rated-quantity-capacity, a ratio of the charging-electricity-quantity to an initial-quantity-capacity, or a ratio of the charging-electricity-quantity to the actual-quantity-capacity; wherein the weighted discharging-electricity-quantity comprise: a ratio of the discharging-electricity-quantity to the rated-quantity-capacity, a ratio of the discharging-electricity-quantity to the initial-quantity-capacity, or a ratio of the discharging-electricity-quantity to the actual-quantity-capacity.

14. A lifetime prognosis device for the rechargeable-battery based on the cumulative-consumption-indicators, comprising:
a comprehensive-lifetime-index building module, which is configured to construct the comprehensive-lifetime-index, using one or a plurality of the cumulative-consumption-indicators, for the rechargeable-battery;
a dynamic-degradation-model building module, which is configured to construct, at the appropriate modelling moment, the dynamic-degradation-model for the rechargeable-battery;
a model-inputs building module, which is configured to obtain the available-degradation-data-samples of the rechargeable-battery as the model-inputs of the dynamic-degradation-model;
a remaining-lifetime prognosis module, which is configured to predict the remaining-lifetime of the rechargeable-battery, at the prognosis-execution-time, using the dynamic-degradation-model.

15. An electronic equipment, comprised of:
a memory module, which is configured to store computer instructions;
a processor module, coupled to the memory module, which is configured to execute the computer instructions stored in the memory module to realize the lifetime prognosis method for the rechargeable-battery based on the cumulative-consumption-indicators as described in any one of claims 1-13.
